(19) United States
(12) Patent Application Publication
(10) Pub. No.: US 2025/0272196 A2
(43) Pub. Date: Aug. 28, 2025

(54) DATA PROTECTION TECHNIQUES IN STACKED MEMORY ARCHITECTURES

(71) Applicant: Micron Technology, Inc., Boise, ID (US)

(72) Inventors: Brent Keeth, Boise, ID (US); Ameen D. Akel, Rancho Cordova, CA (US); Shivasankar Gunasekaran, Erie, CO (US); Sai Krishna Mylavarapu, Folsom, CA (US)

(21) Appl. No.: 18/762,284

(22) Filed: Jul. 2, 2024

Related U.S. Application Data
(60) Provisional application No. 63/535,128, filed on Aug. 29, 2023.

(51) Int. Cl. G06F 11/10

(52) U.S. Cl. CPC G06F 11/108; G06F 11/1016

(57) ABSTRACT

Methods, systems, and devices for data protection techniques in stacked memory architectures are described. A memory system having a stacked memory architecture may include error correction information associated with a data set that includes multiple data segments stored across multiple memory arrays and, in some examples, multiple dies of the memory system. As part of a write operation for a first data segment of a data set, the memory system may retrieve the remaining data segments of the data set and calculate error correction information using the first data segment and the remaining data segments. As part of a read operation for a second data segment of the data set, the memory system may retrieve each data segment of the data set and perform an error correction operation on the data set using the error correction information.

### CROSS REFERENCE

The present Application for Patent claims priority to U.S. Patent Application No. 63/535,128 by Keeth et al., entitled “DATA PROTECTION TECHNIQUES IN STACKED MEMORY ARCHITECTURES,” filed Aug. 29, 2023, which is assigned to the assignee hereof, and which is expressly incorporated by reference in its entirety herein.

### TECHNICAL FIELD

The following relates to one or more systems for memory, including data protection techniques in stacked memory architectures.

### BACKGROUND

Memory devices are used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored by the memory cell. To store information, a memory device may write (e.g., program, set, assign) states to the memory cells. To access stored information, a memory device may read (e.g., sense, detect, retrieve, determine) states from the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells in a non-volatile configuration may maintain stored logic states for extended periods of time even in the absence of an external power source. Memory cells in a volatile configuration may lose stored states when disconnected from an external power source.

### BRIEF DESCRIPTION OF THE DRAWINGS

FIG. 1 shows an example of a system that supports data protection techniques in stacked memory architectures in accordance with examples as disclosed herein.

FIG. 2 shows an example of a system that supports data protection techniques in stacked memory architectures in accordance with examples as disclosed herein.

FIGS. 3 and 4 show examples of interface architectures that support data protection techniques in stacked memory architectures in accordance with examples as disclosed herein.

FIGS. 5A and 5B show examples of data sets that support data protection techniques in stacked memory architectures in accordance with examples as disclosed herein.

FIG. 6 shows a block diagram of a logic block that supports data protection techniques in stacked memory architectures in accordance with examples as disclosed herein.

FIGS. 7 through 9 show flowcharts illustrating methods that support data protection techniques in stacked memory architectures in accordance with examples as disclosed herein.

### DETAILED DESCRIPTION

Some memory systems may include a stack of semiconductor dies, including one or more memory dies (e.g., array dies) stacked with a logic die that is operable to access a set of memory arrays distributed across the one or more memory dies. Such a stacked architecture may be implemented as part of a coupled dynamic random access memory (DRAM) system, and may support solutions for memory-centric logic, such as graphics processing units (GPUs), among other implementations. In some examples, a 3D stacked memory system may be closely coupled (e.g., physically coupled, electrically coupled, directly coupled) with a processor, such as a GPU or other host, as part of a physical memory map accessible to the processor. Such coupling may include one or more processors being implemented in a same semiconductor die as at least a portion of a 3D stacked memory system (e.g., as part of a logic die), or one or more processors being implemented in a die that is directly coupled (e.g., fused) with another die that includes at least a portion of a 3D stacked memory system, or otherwise coupled with another die that includes at least a portion of a 3D stacked memory system (e.g., via a silicon interposer or other intervening component). Unlike cache-based memory, a 3D stacked memory system may not be backed by a level of external memory with the same physical addresses. For example, a 3D stacked memory system may be associated with and located within a dedicated base address, where each portion of the system may be non-overlapping within the address.

A stacked memory architecture (e.g., a 3D stacked memory system) may store a data set, such as a codeword or a data stripe, across multiple memory arrays associated with one or more semiconductor dies. In some examples, the data set may be organized into multiple segments (e.g., each associated with a respective memory array, each associated with a respective memory die), and each segment may be protected using a respective set of error correction information, parity bits, or both. However, in some examples, a particular die of the system, or a channel between the die and a logic block of the system, may become damaged or be otherwise associated with errors within the segment of the data set. Because a size of errors within the segment may exceed an error detecting or correcting capability of the error correction information, such a damaged die or channel may result in uncorrectable errors within the data set. In some cases, addresses affected by the damaged die or channel may be marked as defective (e.g., mapped out), which may improve some aspects of an ability of the system to avoid errors (e.g., in the long term, after marking or avoiding the damaged dies or channels). However, doing so may reduce the memory capacity of the system, or may leave data vulnerable to errors (e.g., in the short term, prior to marking the damaged dies or channels).

In accordance with examples as disclosed herein, a memory system having a stacked memory architecture may support data protection techniques (e.g., error control techniques) associated with data sets that each include multiple data segments stored across multiple memory arrays and, in some examples, multiple dies of the memory system. For example, as part of a write operation for a first data segment of a data set, the memory system may retrieve the remaining data segments of the data set and calculate error correction information using the first data segment and the remaining data segments. In some other examples, the memory system may not retrieve the remaining data segments of the data set and may instead retrieve and modify the error correction information using the first data segment. As part of a read operation for a second data segment of the data set, the memory system may retrieve each data segment of the data set and perform an error correction operation on the data set using the error correction information. By supporting data protection techniques associated with data sets that are each stored across multiple memory arrays and, in some examples, multiple dies (e.g., closely-coupled dies, directly-coupled dies), a memory system may support increased integrity of stored data, increased data correction capabilities, and improved reliability and repair techniques, further improving system performance such as increased throughput and reduced latency of a stacked memory architecture.

Features of the disclosure are illustrated and described in the context of systems and dies. Features of the disclosure are further illustrated and described in the context of interface architectures, data channels, and flowcharts.

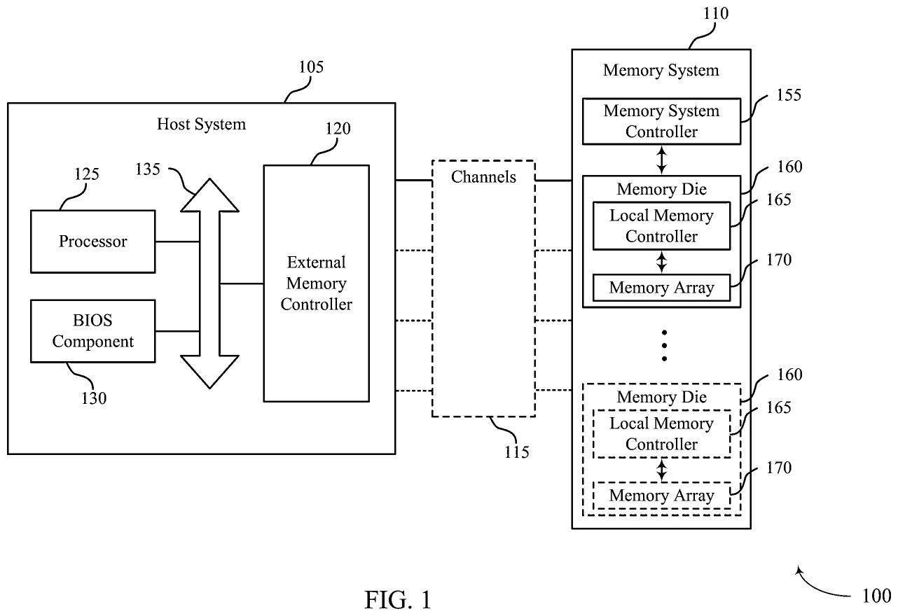

FIG. 1 shows an example of a system 100 that supports data protection techniques in stacked memory architectures in accordance with examples as disclosed herein. The system 100 may include portions of an electronic device, such as a computing device, a mobile computing device, a wireless communications device, a graphics processing device, a vehicle, or other systems. The system 100 includes a host system 105, a memory system 110, and one or more channels 115 coupling the host system 105 with the memory system 110 (e.g., to provide a communicative coupling). The system 100 may include one or more memory systems 110, but aspects of the one or more memory systems 110 may be described in the context of a single memory system 110.

The host system 105 may be an example of a processing system (e.g., circuitry, one or more processors, an application processing system, processing circuitry, one or more processing components) that uses memory to execute processes (e.g., applications, functions, computations), such as a processing system of a computing device, a mobile computing device, a wireless communications device, a graphics processing device, a wearable device, an internet-connected device, a vehicle controller, a system on a chip (SoC), or other stationary or portable electronic device, among other examples. The host system 105 may include one or more of an external memory controller 120, a processor 125, a basic input/output system (BIOS) component 130, or other components (e.g., a peripheral component, an input/output controller, not shown). The components of the host system 105 may be coupled with one another using a bus 135.

An external memory controller 120 may be configured to enable communication of information (e.g., data, commands, control information, configuration information) between components of the system 100 (e.g., between components of the host system 105, such as the processor 125, and the memory system 110). For example, an external memory controller 120 may generate commands (e.g., in response to or to otherwise support an application of the host system 105) to write data to a memory system 110, or to read data from the memory system 110, or to otherwise communicate with a memory system 110. An external memory controller 120 may process (e.g., convert, translate) communications exchanged between the host system 105 and the memory system 110. In some examples, an external memory controller 120, or other component of the system 100, or associated functions described herein, may be implemented by or be part of the processor 125. For example, an external memory controller 120 may be hardware, firmware, or software (e.g., instructions), or some combination thereof implemented by a processor 125 or other component of the system 100 or the host system 105. Although an external memory controller 120 is illustrated outside the memory system 110, in some examples, an external memory controller 120, or its functions described herein, may be implemented by one or more components of a memory system 110 (e.g., a memory system controller 155, a local memory controller 165) or vice versa. In various examples, the host system 105 or an external memory controller 120 may be referred to as a host.

A processor 125 may be operable to provide functionality (e.g., control functionality, processing functionality) for the system 100 or the host system 105. A processor 125 may be a general-purpose processor, a digital signal processor (DSP), an application-specific integrated circuit (ASIC), a field-programmable gate array (FPGA) or other programmable logic device, discrete gate or transistor logic, discrete hardware components, or any combination thereof (e.g., as one or more processing components that are configured individually or collectively to support an application of the host system 105). In some examples, a processor 125 may be an example of a central processing unit (CPU), a graphics processing unit (GPU), a general-purpose GPU (GPGPU), or an SoC, among other examples.

In some examples, the system 100 or the host system 105 may include an input component, an output component, or a combination thereof. Input components may include a sensor, a microphone, a keyboard, another processor (e.g., on a printed circuit board), an interface (e.g., a user interface, an interface between other devices), or a peripheral that interfaces with system 100 via one or more peripheral components, among other examples. Output components may include a display, audio speakers, a printing device, another processor on a printed circuit board, or a peripheral that interfaces with the system 100 via one or more peripheral components, among other examples.

The memory system 110 may be a component of the system 100 that is operable to provide physical memory locations (e.g., addresses) that may be used or referenced by the system 100 (e.g., by the host system 105). The memory system 110 may include a memory system controller 155 and one or more memory dies 160 (e.g., memory chips) to support a capacity for data storage. The memory system 110 may be configurable to work with one or more different types of host systems 105, and may respond to and execute commands provided by the host system 105 (e.g., via an external memory controller 120). For example, the memory system 110 (e.g., a memory system controller 155) may receive a write command indicating that the memory system 110 is to store data received from the host system 105, or receive a read command indicating that the memory system 110 is to provide data stored in a memory die 160 to the host system 105, or receive a refresh command indicating that the memory system 110 is to refresh data stored in a memory die 160, among other types of commands and operations.

A memory system controller 155 may include components (e.g., circuitry, logic, instructions) operable to control operations of the memory system 110. A memory system controller 155 may include hardware, firmware, or instructions that enable the memory system 110 to perform various operations, and may be operable to receive, transmit, or execute commands, data, or control information related to operations of the memory system 110. A memory system controller 155 may be operable to communicate with one or more of an external memory controller 120, one or more memory dies 160, or a processor 125. In some examples, a memory system controller 155 may control operations of the memory system 110 in cooperation with a local memory controller 165 of a memory die 160.

Each memory die 160 may include one or more local memory controllers 165 and one or more memory arrays 170. A memory array 170 may be a collection of memory cells, with each memory cell being operable to store one or more bits of data. A memory array 170 may include a two-dimensional (2D) array of memory cells, or a three-dimensional (3D) array of memory cells. In some examples, a two-dimensional (2D) memory die 160 may include a single memory array 170. In some examples, a three-dimensional (3D) memory die 160 may include two or more memory arrays 170, which may be stacked or positioned beside one another (e.g., relative to a substrate).

A local memory controller 165 may include components (e.g., circuitry, logic, instructions) operable to control operations of a memory die 160. In some examples, a local memory controller 165 may be operable to communicate (e.g., receive or transmit data or commands or both) with a memory system controller 155. In some examples, a memory system 110 may not include a memory system controller 155, and a local memory controller 165 or an external memory controller 120 may perform various functions described herein. As such, a local memory controller 165 may be operable to communicate with a memory system controller 155, with other local memory controllers 165, or directly with an external memory controller 120, or a processor 125, or any combination thereof. Examples of components that may be included in a memory system controller 155 or a local memory controller 165 or both may include receivers for receiving signals (e.g., from the external memory controller 120), transmitters for transmitting signals (e.g., to the external memory controller 120), decoders for decoding or demodulating received signals, encoders for encoding or modulating signals to be transmitted, sense components for sensing states of memory cells of a memory array 170, write components for writing states to memory cells of a memory array 170, or various other components operable for supporting described operations of a memory system 110.

A host system 105 (e.g., an external memory controller 120) and a memory system 110 (e.g., a memory system controller 155) may communicate information (e.g., data, commands, control information, configuration information) using one or more channels 115. Each channel 115 may be an example of a transmission medium that carries information, and each channel 115 may include one or more signal paths (e.g., a transmission medium, an electrical conductor, an electrically conductive path) between terminals associated with the components of the system 100. For example, a channel 115 may be associated with a first terminal (e.g., including one or more pins, including one or more pads) at the host system 105 and a second terminal at the memory system 110. A terminal may be an example of a conductive input or output point of a device of the system 100, and a terminal may be operable to act as part of a channel 115. In some implementations, at least the channels 115 between a host system 105 and a memory system 110 may include or be referred to as a host interface (e.g., a physical host interface). In some implementations, a host interface may include or be associated with interface circuitry (e.g., signal drivers, signal latches) at the host system 105 (e.g., at an external memory controller 120), or at the memory system 110 (e.g., at a memory system controller 155), or both.

In some examples, a channel 115 (e.g., associated signal paths and terminals) may be dedicated to communicating one or more types of information. For example, the channels 115 may include one or more command and address channels, one or more clock signal channels, one or more data channels, among other channels or combinations thereof. In some examples, signaling may be communicated via the channels 115 using single data rate (SDR) signaling or double data rate (DDR) signaling. In SDR signaling, one modulation symbol (e.g., signal level) of a signal may be registered for each clock cycle (e.g., on a rising or falling edge of a clock signal). In DDR signaling, two modulation symbols of a signal may be registered for each clock cycle (e.g., on both a rising edge and a falling edge of a clock signal).

In some examples, at least a portion of the system 100 may implement a stacked die architecture in which multiple semiconductor dies are physically and communicatively coupled. In some such implementations, circuitry for accessing one or more memory arrays 170 (e.g., circuitry of a memory system 110) may be distributed among multiple semiconductor dies of a stack (e.g., a stack of multiple directly-coupled semiconductor dies). For example, a first die may include a set of multiple first interface blocks (e.g., memory interface blocks, instances of first interface circuitry) and one or more second dies may include corresponding second interface blocks, each coupled with a first interface block of the first die, that are each configured to access one or more memory arrays of the second dies. In some examples, the system may include a controller (e.g., a memory controller, an interface controller, a host interface controller, at least a portion of an external memory controller 120) for each set of one or more first interface blocks to support access operations (e.g., to access one or more memory arrays 170) via the set of first interface blocks. In some examples, such controllers may be located in the same first die as the first interface blocks.

In some examples, multiple semiconductor dies of a memory system 110 (e.g., a 3D stacked memory system) may include one or more array dies (e.g., memory dies 160) stacked with a logic die (e.g., that includes the host system 105, that is coupled with another die that includes the host system 105) that includes interface blocks operable to access a set of memory arrays 170 distributed across the one or more second dies. A memory system 110 having a stacked memory architecture may support data protection techniques associated with data sets that each include multiple data segments stored across multiple memory arrays 170 and, in some examples, multiple memory dies 160 of the memory system 110. For example, as part of a write operation for a first data segment of a data set (e.g., in response to a command from a host system 105), the memory system 110 may retrieve the remaining data segments of the data set and calculate error correction information using the first data segment and the remaining data segments. In some other examples, the memory system 110 may not retrieve the remaining data segments of the data set and may instead retrieve and modify the error correction information using the first data segment. As part of a read operation for a second data segment of the data set, the memory system 110 may retrieve each data segment of the data set and perform an error correction operation on the data set using the error correction information. By supporting data protection techniques associated with data sets that are each stored across multiple memory arrays 170 and, in some examples multiple memory dies 160, a memory system 110 may support increased integrity of stored data, increased data correction capabilities, and improved reliability and repair techniques, further improving system performance such as increased throughput and reduced latency of a stacked memory architecture.

In addition to applicability in systems as described herein, management command techniques for stacked memory architectures may be generally implemented to support artificial intelligence or machine learning applications, among other types of computationally-intensive applications. As the use of artificial intelligence increases to support machine learning, analytics, decision making, or other related applications, electronic devices that support artificial intelligence applications and processes may be desired. For example, artificial intelligence applications may be associated with accessing relatively large quantities of data for analytical purposes and may benefit from memory systems capable of effectively and efficiently storing relatively large quantities of data or accessing stored data relatively quickly. Implementing the techniques described herein may support artificial intelligence and machine learning techniques by improving integrity of data stored to multiple memory dies 160, including by increasing error detection and correction capability of error correction information associated with a codeword stored across the multiple memory dies 160. Such techniques may improve reliability of data stored within memory arrays (e.g., of a closely-coupled stack of array dies), supporting high-performance host applications with the increased throughput and reduced latency of stacked memory architectures.

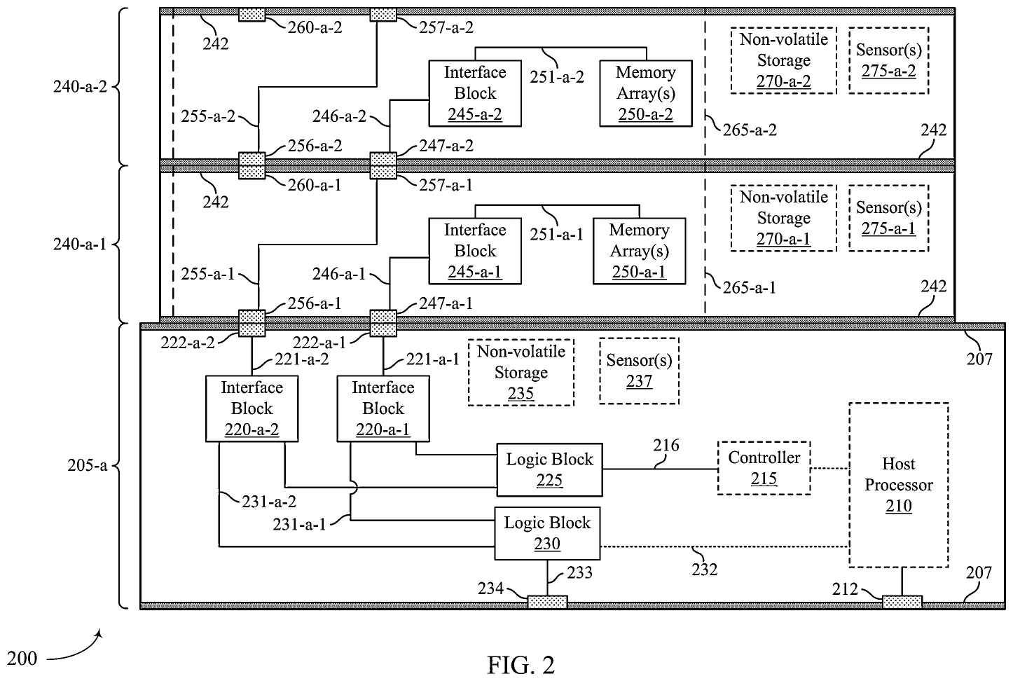

FIG. 2 shows an example of a system 200 (e.g., a semiconductor system, a system of coupled semiconductor dies, a 3D stacked memory system) that supports data protection techniques in stacked memory architectures in accordance with examples as disclosed herein. The system 200 illustrates an example of a die 205 (e.g., a die 205-a, a semiconductor die, a logic die, a processor die, a host die) that is coupled with one or more dies 240 (e.g., dies 240-a-1 and 240-a-2, semiconductor dies, memory dies, array dies). A die 205 or a die 240 may be formed using a respective semiconductor substrate (e.g., a substrate of crystalline semiconductor material such as silicon, germanium, silicon-germanium, gallium arsenide, or gallium nitride), or a silicon-on-insulator (SOI) substrate (e.g., silicon-on-glass (SOG), silicon-on-sapphire (SOS)), or epitaxial semiconductor materials formed on another substrate, among other examples. Although the illustrated example of a system 200 includes two dies 240, a system 200 in accordance with the described techniques may include any quantity of one or more dies 240 coupled with a die 205, among other dies of a stack or other coupled layout. Further, although non-limiting examples of the system 200 herein are generally described in terms of applicability to memory systems, memory sub-systems, memory devices, or a combination thereof, examples of the system 200 are not so limited. For example, aspects of the present disclosure may be applied as well to any computing system, computing sub-system, processing system, processing sub-system, component, device, structure, or other types of systems or sub-systems used for applications such as data collecting, data processing, data storage, networking, communication, power, artificial intelligence, system-on-a-chip, control, telemetry, sensing and monitoring, digital entertainment, or any combination thereof.

The system 200 illustrates an example of interface circuitry between a host and memory (e.g., via a host interface, via a physical host interface) that is implemented in (e.g., divided between) multiple semiconductor dies (e.g., a stack of directly-coupled dies). For example, the die 205-a may include a set of one or more interface blocks 220 (e.g., interface blocks 220-a-1 and 220-a-2, memory interface blocks), and each die 240 may include a set of one or more interface blocks 245 (e.g., access interface blocks) and one or more memory arrays 250 (e.g., die 240-a-1 including an interface block 245-a-1 coupled with a set of one or more memory arrays 250-a-1, die 240-a-2 including an interface block 245-a-2 coupled with a set of one or more memory arrays 250-a-2). The memory arrays 250 may be examples of memory arrays 170, and may include memory cells of various architectures, such as RAM, DRAM, SDRAM, SRAM, FeRAM, MRAM, RRAM, PCM, chalcogenide, NOR, or NAND memory cells, or any combination thereof.

Although the example of system 200 is illustrated with one interface block 245 included in each die 240, a die 240 in accordance with the described techniques may include any quantity of one or more interface blocks 245, each coupled with a respective set of one or more memory arrays 250, and each coupled with an interface block 220 of a die 205. Thus, the interface circuitry of a system 200 may include one or more interface blocks 220 of a die 205, with each interface block 220 being coupled with (e.g., in communication with) one or more interfaces block 245 of a die 240 (e.g., external to the die 205). In some examples, a coupled combination of an interface block 220 and an interface block 245 (e.g., coupled via a bus associated with one or more channels, such as one or more data channels, one or more control channels, one or more clock channels, one or more pseudo-channels, or a combination thereof) may include or be referred to as a data path associated with a respective set of one or more memory arrays 250.

In some implementations, a die 205 may include a host processor 210. A host processor 210 may be an example of a host system 105, or a portion thereof (e.g., a processor 125, aspects of an external memory controller 120, or both). The host processor 210 may be configured to perform operations that implement storage of the memory arrays 250 (e.g., to support an application or other function of a host system 105, which may request access of the memory arrays 250). For example, the host processor 210 may receive data read from the memory arrays 250, or may transmit data to be written to the memory arrays 250, or both (e.g., in accordance with an application or other operations of the host processor 210). Additionally, or alternatively, a host processor 210 may be external to a die 205, such as in another semiconductor die or other component that is coupled with (e.g., communicatively coupled with, directly coupled with, bonded with, coupled via another intervening component) the die 205 via one or more contacts 212 (e.g., externally-accessible terminals of the die 205).

A host processor 210 may be configured to communicate (e.g., transmit, receive) signaling with interface blocks 220 via a host interface 216 (e.g., a physical host interface), which may implement aspects of channels 115 described with reference to FIG. 1. In some examples, a host interface 216 may provide a communicative coupling between physical or functional boundaries of a host system 105 and a memory system 110. For example, the host processor 210 may be configured to communicate access signaling (e.g., control signaling, access command signaling, data signaling, configuration signaling) via a host interface 216 to support access operations (e.g., read operations, write operations) on the memory arrays 250, among other operations. Although the example of system 200 includes a single host interface 216, a system in accordance with the described techniques may include any quantity of one or more host interfaces 216 for accessing memory arrays 250 of the system.

In some examples, a respective host interface 216 may be coupled between a set of one or more interface blocks 220 (e.g., interface blocks 220-a-1 and 220-a-2) and a respective controller 215. A controller 215 may be an example of control circuitry (e.g., memory controller circuitry, host interface control circuitry) associated with a host system 105, and may be associated with implementing respective instances of one or more aspects of an external memory controller 120, or of a memory system controller 155, or a combination thereof. For example, the controller 215 may be operable to respond to indications (e.g., requests, commands) from the host processor 210 to access one or more memory arrays 250 in support of a function or application of the host processor 210, to transmit associated commands (e.g., for one or more interface blocks 220) to access the one or more memory arrays 250, and to communicate data (e.g., write data, read data) with the host processor 210, among other functions.

In some examples, one or more controllers 215 may be implemented in a die 205 (e.g., the same die that includes one or more interface blocks 220) whether a host processor 210 is included in the die 205, or is external to the die 205. In some other examples, controllers 215 or associated circuitry or functionality may be implemented external to a die 205 (e.g., in another die, not shown, coupled with respective interface blocks 220 via respective terminals for each of the respective host interfaces 216), which may be in the same die as or a different die from a die that includes a host processor 210. An interface block 220 may be operable via a single controller 215, or by one or more of a set of multiple controllers 215 (e.g., in accordance with a controller multiplexing scheme). In some other examples, aspects of one or more controllers 215 may be included in the host processor 210 (e.g., as a memory interface of the host processor 210, as a memory interface of a host system 105).

Although, in some examples, a controller 215 may be directly coupled with one or more interface blocks 220 (not shown), in some other examples, a controller 215 (e.g., a host interface 216) may be coupled with a set of multiple interface blocks 220 via a logic block 225 (e.g., logic circuitry for a channel set, logic circuitry for a host interface 216, multiplexing circuitry). For example, the logic block 225 may be coupled with the interface block 220-a-1 via a bus 223-a-1 and coupled with the interface block 220-a-2 via a bus 223-a-2. A controller 215 and one or more corresponding interface blocks 220 may communicate (e.g., collaborate) using the host interface 216 via a logic block 225 to perform one or more operations (e.g., scheduling operations, access operations, operations initiated by a host processor 210) associated with accessing a corresponding set of one or more memory arrays 250.

In some examples, a logic block 225, a controller 215, or a host interface 216, or a combination thereof may be associated with a “channel set” that corresponds to multiple memory arrays 250 (e.g., for parallel or otherwise coordinated access of the multiple memory arrays 250). For example, such a channel set may be associated with multiple memory arrays 250 accessed via a single interface block 245, or multiple memory arrays 250 each accessed via a respective one of the interface blocks 245, or multiple memory arrays 250 each accessed via a respective one of the interface blocks 220, any of which may be associated with signaling via a single logic block 225, via a single host interface 216, or via a single controller 215. These and other configurations for implementing one or more channel sets in a system may support various techniques for parallelism and high bandwidth data transfer, memory management operations, repair and replacement techniques, or power and thermal distribution, among other techniques that leverage the described coupling of components and interfaces among multiple semiconductor dies (e.g., in accordance with the closely-coupled configuration of the system 200). In some examples, such techniques may be implemented (e.g., at or using a logic block 225) in a manner that is transparent to the host interface 216 or other aspects of a host system 105.

In some examples, a host interface 216 may include a respective set of one or more signal paths for each logic block 225 or interface block 220, such that the host processor 210 may communicate with each logic block 225 or interface block 220 via its corresponding set of signal paths (e.g., in accordance with a selection of the corresponding set to perform access operations via a logic block 225 or interface block 220 that is selected by the host processor 210). Additionally, or alternatively, a host interface 216 may include one or more signal paths that are shared among multiple logic blocks 225 (not shown) or interface blocks 220, and a logic block 225, an interface block 220, or a host processor 210, or any of these may interpret, ignore, respond to, or inhibit response to signaling via shared signal paths of the host interface 216 based on a logical indication (e.g., an addressing indication associated with the logic block 225 or interface block 220, an interface enable signal, or an interface select signal, which may be provided by the host processor 210, the corresponding logic block 225, or the corresponding interface block 220 depending on signaling direction).

In some examples, a host processor 210 may determine to access an address (e.g., a logical address of a memory array 250, a physical address of a memory array 250, an address of a logic block 225, an address of an interface block 220, an address of a host interface 216, in response to an application of or supported by the host processor 210), and determine which controller 215 to transmit access signaling to for accessing the address (e.g., a controller 215, logic block 225, or interface block 220 corresponding to the address). In some examples, the address may be associated with a row of memory cells of the memory array 250, a column of memory cells of the memory array 250, or both. The host processor 210 may transmit access signaling (e.g., one or more access signals, one or more access commands) to the determined controller 215 and, in turn, the determined controller 215 may transmit access signaling to the corresponding logic block 225 or interface block 220. The corresponding interface block 220 may subsequently transmit access signaling to the coupled interface block 245 to access the determined address (e.g., of a corresponding memory array 250).

A die 205 may also include a logic block 230 (e.g., a shared logic block, a central logic block, common logic circuitry, evaluation circuitry, memory system configuration circuitry, memory system management circuitry), which may be configured to communicate (e.g., transmit, receive) signaling with the logic blocks 225, the interface blocks 220, or both of the die 205. In some cases, a logic block 230 may be configured to communicate information (e.g., commands, instructions, indications, data) with one or more logic blocks 225 or interface blocks 220 to facilitate operations of the system 200. For example, a logic block 230 may be configured to transmit configuration signaling (e.g., initialization signaling, evaluation signaling, mapping signaling), which may be received by logic blocks 225 or interface blocks 220 to support configuration of the logic blocks 225 or interface blocks 220, or other aspects of operating the dies 240 (e.g., via the respective interface blocks 245). A logic block 230 may be coupled with each logic block 225 and each interface block 220 via a respective bus. In some examples, such buses may each include a respective set of one or more signal paths, such that a logic block 230 may communicate with each logic block 225 or each interface block 220 via the respective set of signal paths. Additionally, or alternatively, such buses may include one or more signal paths that are shared among multiple logic blocks 225 or interface blocks 220 (not shown).

In some implementations, a logic block 230 may be configured to communicate (e.g., transmit, receive) signaling with a host processor 210 (e.g., via a bus, via a contact 212 for a host processor 210 external to a die 205) such that the logic block 230 may support an interface between the host processor 210 and the logic blocks 225 or interface blocks 220. For example, a host processor 210 may be configured to transmit initialization signaling (e.g., boot commands), or other configuration or operational signaling, which may be received by a logic block 230 to support initialization, configuration, evaluation, or other operations of the logic blocks 225 or interface blocks 220. Additionally, or alternatively, in some implementations, a logic block 230 may be configured to communicate (e.g., transmit, receive) signaling with a component outside the system 200 (e.g., via a contact 234, which may be an externally-accessible terminal of the die 205), such that the logic block 230 may support an interface that bypasses a host processor 210. Additionally, or alternatively, a logic block 230 may communicate with a host processor 210, and may communicate with one or more memory arrays 250 of one or more dies 240 (e.g., to perform self-test operations for access of memory arrays 250). In some examples, such implementations may support evaluations, configurations, or other operations of the system 200, via one or more contacts 234 that are accessible at a physical interface of the system, during manufacturing, assembly, validation, or other operation associated with the system 200 (e.g., before coupling with a host processor 210, without implementing a host processor 210, for operations independent of a host processor). Additionally, or alternatively, a logic block 230 may implement one or more aspects of a controller 215. For example, a logic block 230 may include or operate as one or more controllers 215 and may perform operations ascribed to a controller 215.

Each interface block 220 may be coupled with at least a respective bus 221 of the die 205, and a respective bus 246 of a die 240, that are configured to communicate signaling with a corresponding interface block 245 (e.g., via one or more associated signal paths). For example, the interface block 220-a-1 may be coupled with the interface block 245-a-1 via a bus 221-a-1 and a bus 246-a-1, and the interface block 220-a-2 may be coupled with the interface block 245-a-2 via a bus 221-a-2 and a bus 246-a-2. In some examples, a die 240 may include a bus that bypasses operational circuitry of the die 240 (e.g., that bypasses interface blocks 245 of a given die 240), such as a bus 255. For example, the interface block 220-a-2 may be coupled with the interface block 245-a-2 of the die 240-a-2 via a bus 255-a-1 of the die 240-a-1, which may bypass interface blocks 245 of the die 240-a-1. Such techniques may be extended for interconnection among more than two dies 240 (e.g., for interconnection via a respective bus 255 of multiple dies 240).

The respective signal paths of buses 221, 246, and 255 may be coupled with one another, from one die to another, via various arrangements of contacts at the surfaces of interfacing dies (e.g., exposed contacts, metal surfaces of the respective dies). For example, the bus 221-a-1 may be coupled with the bus 246-a-1 via a contact 222-a-1 of (e.g., at a surface of) the die 205-a and a contact 247-a-1 of the die 240-a-1, the bus 221-a-2 may be coupled with the bus 255-a-1 via a contact 222-a-2 of the die 205 and a contact 256-a-1 of the die 240-a-1, the bus 255-a-1 may be coupled with the bus 246-a-2 via a contact 257-a-1 of the die 240-a-1 and a contact 247-a-2 of the die 240-a-2, and so on. Although each respective bus is illustrated with a single line, coupled via singular contacts, it is to be understood that each signal path of a given bus may be associated with respective contacts to support a separate communicative coupling via each signal path of the given bus. In some examples, a bus 255 may traverse a portion of a die 240 (e.g., in an in-plane direction, along a direction different from a thickness direction, in a waterfall arrangement, in a staircase arrangement), which may support an arrangement of contacts 222 along a surface of a die 205, among other contacts, being coupled with interface blocks 245 of different dies 240 along a stack direction (e.g., via respective contacts 256 and 257 that are non-overlapping when viewed along a thickness direction).

The interconnection of interfacing contacts may be supported by various techniques. For example, in a hybrid bonding implementation, interfacing contacts may be coupled by a fusion of conductive materials (e.g., electrically conductive materials) of the interfacing contacts (e.g., without solder or other intervening material between contacts). For example, in an assembled condition, the coupling of the die 205-a with the die 240-a-1 may include a conductive material of the contact 222-a-2 being fused with a conductive material of the contact 256-a-1, and the coupling of the die 240-a-1 with the die 240-a-2 may include a conductive material of the contact 257-a-1 being fused with a conductive material of the contact 247-a-2, and so on. In some examples, such coupling may include an inoperative fusion of contacts (e.g., a non-communicative coupling, a physical coupling), such as a fusion of the contact 260-a-1 with the contact 256-a-2, neither of which are coupled with operative circuitry of the dies 240-a-1 or 240-a-2. In some examples, such techniques may be implemented to improve coupling strength or uniformity (e.g., implementing contacts 260, which may not be operatively coupled with an interface block 245 or an interface block 220), or such a coupling may be a byproduct of a repetition of components that, in various configurations, may be operative or inoperative. (e.g., where, for dies 240 with a common arrangement of contacts 256 and 257, contacts 256-a-1 and 257-a-1 provide a communicative path between the interface block 245-a-2 and the interface block 220-a-2, but the contacts 256-a-2 and 257-a-2 do not provide a communicative path between an interface block 245 and an interface block 220).

In some examples, a fusion of conductive materials between dies (e.g., between contacts) may be accompanied by a fusion of other materials at one or more surfaces of the interfacing dies. For example, in an assembled condition, the coupling of the die 205 with the die 240-a-1 may include a dielectric material 207 (e.g., an electrically non-conductive material) of the die 205-a being fused with a dielectric material 242 of the die 240-a-1, and the coupling of the die 240-a-1 with the die 240-a-2 may include a dielectric material 242 of the die 240-a-1 being fused with a dielectric material 242 of the die 240-a-2. In some examples, such dielectric materials may include an oxide, a nitride, a carbide, an oxide-nitride, an oxide-carbide, or other conversion or doping of a substrate material (e.g., a semiconductor substrate material) of the die 205 or dies 240, among other materials that may support such fusion. However, coupling among dies 205 and dies 240 may be implemented in accordance with other techniques, which may implement solder, adhesives, thermal interface materials, and other intervening materials.

In some examples, dies 240 may be coupled in a stack (e.g., forming a “cube” or other arrangement of dies 240), and one or more of such stacks may subsequently be coupled with a die 205 (e.g., in a stack-to-chip bonding arrangement). In some examples, respective set(s) of one or more dies 240 may be coupled with each die 205 of multiple dies 205 as formed in a wafer (e.g., in a chip-to-wafer bonding arrangement, in a stack-to-wafer bonding arrangement, before cutting the wafer of dies 205), and the dies 205 of the wafer, each coupled with their respective set(s) of dies 240, may be separated from one another (e.g., by cutting at least the wafer of dies 205). In some other examples, respective set(s) of one or more dies 240 may be coupled with a respective die 205 after the die 205 is separated from a wafer of dies 205 (e.g., in a chip-to-chip bonding arrangement). In some other examples, a respective set of one or more wafers, each including multiple dies 240, may be coupled in a stack (e.g., in a wafer-to-wafer bonding arrangement). In various examples, such techniques may be followed by separating stacks of dies 240 from the coupled wafers, or the stack of wafers having dies 240 may be coupled with another wafer including multiple dies 205 (e.g., in a second wafer-to-wafer bonding arrangement), which may be followed by separating systems 200 from the coupled wafers. In some other examples, wafer-to-wafer coupling techniques may be implemented by stacking one or more wafers of dies 240 (e.g., sequentially) over a wafer of dies 205 before separation into systems 200, among other examples for forming systems 200.

The buses 221, 246, and 255 may be implemented to provide a configured signaling (e.g., a coordinated signaling, a logical signaling, modulated signaling, digital signaling) between an interface block 220 and a corresponding interface block 245, which may involve various modulation or encoding techniques by a transmitting interface block (e.g., via a driver component of the transmitting interface block). In some examples, such signaling may be supported by (e.g., accompanied by) clock signaling communicated via the respective buses (e.g., in coordination with signal transmission). For example, the buses may be configured to convey one or more clock signals transmitted by the interface block 220 for reception by the interface block 245 (e.g., to trigger signal reception by a latch or other reception component of the interface block 245, to support clocked operations of the interface block 245). Additionally, or alternatively, the buses may be configured to convey one or more clock signals transmitted by the interface block 245 for reception by the interface block 220 (e.g., to trigger signal reception by a latch or other reception component of the interface block 220, to support clocked operations of the interface block 220). Such clock signals may be associated with the communication (e.g., unidirectional communication, bidirectional communication, deterministic communication) of various signaling, such as control signaling, command signaling, data signaling, or any combination thereof. For example, the buses may include one or more signal paths for communications of a data bus (e.g., one or more data channels, a DQ bus, via a data interface of the interface blocks) in accordance with one or more corresponding clock signals (e.g., data clock signals), or one or more signal paths for communications of a control bus (e.g., a command/address (C/A) bus, via a command interface of the interface blocks) in accordance with one or more clock signals (e.g., control clock signals), or any combination thereof.

Interface blocks 220, interface blocks 245, logic blocks 225, and a logic block 230 each may include circuitry (signaling circuitry, multiplexing circuitry, processing circuitry, controller circuitry, logic circuitry, physical components, hardware) in various configurations (e.g., hardware configurations, logic configurations, software or instruction configurations) that support the functionality allocated to the respective block for accessing or otherwise operating a corresponding set of memory arrays 250. For example, interface blocks 220 may include circuitry configured to perform a first subset of operations that support access of the memory arrays 250, and interface blocks 245 may include circuitry configured to perform a second subset of operations that support access of the memory arrays 250. In some examples, the interface blocks 220, the interface blocks 245, and logic blocks 225 may support a functional split or distribution of functionality associated with a memory system controller 155, a local memory controller 165, or both across multiple dies (e.g., a die 205 and at least one die 240). In some implementations, a logic block 230 may be configured to coordinate or configure aspects of the operations of the interface blocks 220, of the interface blocks 245, of the logic blocks 225, or a combination thereof, and may support implementing one or more aspects of a memory system controller 155. Such operations, or subsets of operations, may include operations performed in response to commands from the host processor 210 or a controller 215, or operations performed without commands from a host processor 210 or a controller 215 (e.g., operations determined by or initiated by a logic block 225, operations determined by or initiated by an interface block 220, operations determined by or initiated by an interface block 245, operations determined by or initiated by a logic block 230), or various combinations thereof.

In some implementations, the system 200 may include one or more instances of non-volatile storage (e.g., non-volatile storage 235 of a die 205, non-volatile storage 270 of one or more dies 240, or a combination thereof). In some examples, a logic block 230, logic blocks 225, interface blocks 220, interface blocks 245, or a combination thereof may be configured to communicate signaling with one or more instances of non-volatile storage. For example, a logic block 230, logic blocks 225, interface blocks 220, or interface blocks 245 may be coupled with one or more instances of non-volatile storage via one or more buses (not shown), or respective contacts (not shown), where applicable, which may each include one or more signal paths operable to communicate signaling (e.g., command signaling, data signaling). In some examples, a logic block 230, one or more logic blocks 225, one or more interface blocks 220, one or more interface blocks 245, or a combination thereof may configure one or more operations based on information (e.g., instructions, configurations, parameters) stored in one or more instances of non-volatile storage. Additionally, or alternatively, in some examples, a logic block 230, one or more logic blocks 225, one or more interface blocks 220, one or more interface blocks 245, or a combination thereof may write information (e.g., configuration information, evaluation information) to be stored in one or more instances of non-volatile storage. In some examples, such non-volatile storage may include fuses, antifuses, or other types of one-time programmable storage elements, or any combination thereof.

In some implementations, the system 200 may include one or more sensors (e.g., one or more sensors 237 of a die 205, one or more sensors 275 of one or more dies 240, or a combination thereof). In some implementations, a logic block 230, logic blocks 225, interface blocks 220, interface blocks 245, or a combination thereof may be configured to receive one or more indications based on measurements of one or more sensors of the system 200. For example, a logic block 230, logic blocks 225, interface blocks 220, or interface blocks 245 may be coupled with one or more sensors via one or more buses (not shown), or respective contacts (not shown). Such sensors may include temperature sensors, current sensors, voltage sensors, counters, and other types of sensors. In some examples, a logic block 230, one or more logic blocks 225, one or more interface blocks 220, one or more interface blocks 245, or a combination thereof may configure one or more operations based on output of the one or more sensors. For example, a logic block 230 may configure one or more operations of logic blocks 225 or interface blocks 220 based on signaling (e.g., indications, data) received from the one or more sensors. Additionally, or alternatively, a logic block 225 or an interface block 220 may generate access signaling for transmitting to a corresponding interface block 245 based on one or more sensors.

In some examples, circuitry of logic blocks 225, interface blocks 220, interface blocks 245, or a logic block 230, or any combination thereof may include components (e.g., transistors) formed at least in part from doped portions of a substrate of the respective die. In some examples, a substrate of a die 205 may have characteristics (e.g., materials, material characteristics, physical shapes or dimensions) that are different from those of a substrate of a die 240. Additionally, or alternatively, in some examples, transistors formed from a substrate of a die 205 may have characteristics (e.g., manufacturing characteristics, performance characteristics, physical shapes or dimensions) that are different from transistors formed from a substrate of a die 240 (e.g., in accordance with different transistor architectures, in accordance with different transistor designs).

In some examples, the interface blocks 220 may support a layout for one or more components within the interface blocks 220. For example, the layout may include pairing components to share an access port (e.g., a command port, a data port). Further, in some examples, the layout may support interfaces for a controller 215 (e.g., a host interface 216) that are different from interfaces for an interface block 245 (e.g., via the buses 221). For instance, a host interface 216 may be synchronous and have separate channels for read and write operations, while an interface between an interface block 220 and one or more interface blocks 245 may be asynchronous and support both read and write operations with the same channel. In some examples, signaling of a host interface 216 may be implemented with a deterministic timing (e.g., deterministic between a controller 215 and a logic block 225 or one or more interface blocks 220), which may be associated with a configured timing between a first signal and a responsive second signal. In some examples, signaling between an interface block 220 and one or more interface blocks 245 may be implemented with a timing that is different from timing of a host interface 216 (e.g., in accordance with a different clock frequency, in accordance with a timing offset, such as a phase offset), which may be deterministic or non-deterministic.

A die 240 may include one or more units 265 (e.g., modules) that are separated from a semiconductor wafer having a pattern (e.g., a two-dimensional pattern) of units 265. Although each die 240 of the system 200 is illustrated with a single unit 265 (e.g., unit 265-a-1 of die 240-a-1, unit 265-a-2 of die 240-a-2), a die 240 in accordance with the described techniques may include any quantity of units 265, which may be arranged in various patterns (e.g., sets of one or more units 265 along a row direction, sets of one or more units 265 along a column direction, among other patterns). Each unit 265 may include at least the circuitry of a respective interface block 245, along with memory array(s) 250, a bus 251, a bus 246, and one or more contacts 247 corresponding to the respective interface block 245. In some examples, where applicable, each unit 265 may also include one or more buses 255, contacts 256, contacts 257, or contacts 260 (e.g., associated with a respective interface block 245 of a unit 265 of a different die 240), which may support various degrees of stackability or modularity among or via units 265 of other dies 240. Although examples of non-volatile storage 270 and sensors 275 are illustrated outside units 265, in some other examples, non-volatile storage 270, sensors 275, or both may additionally, or alternatively, be included in units 265.

In some examples, the interface blocks 220 may include circuitry configured to receive first access command signaling (e.g., from a host processor 210, from a controller 215, from a logic block 225, via a host interface 216, via one or more contacts 212 from a host processor 210 or controller 215 external to a die 205, based on a request from a host application), and to transmit second access command signaling to the respective (e.g., coupled) interface block 245 based on (e.g., in response to) the received first access command signaling. The interface blocks 245 may accordingly include circuitry configured to receive the second access command signaling from the respective interface block 220 and, in some examples, to access a respective set of one or more memory arrays 250 based on (e.g., in response to) the received second access command signaling. In various examples, the first access command signaling may include access commands that are associated with a type of operation (e.g., a read operation, a write operation, a refresh operation, a memory management operation), which may be associated with an indication of an address of the one or more memory arrays 250 (e.g., a logical address, a physical address). In some examples, the first access command signaling may include an indication of a logical address associated with the memory arrays 250, and circuitry of an interface block 220 may be configured to generate the second access command signaling to indicate a physical address associated with the memory arrays 250 (e.g., a row address, a column address, using a logical-to-physical (L2P) table or other mapping or calculation functionality of the interface block 220).

In some examples, to support write operations of the system 200, circuitry of the interface blocks 220 may be configured to receive (e.g., from a host processor 210, from a controller 215, from a logic block 225) first data signaling associated with the first access command signaling, and to transmit second data signaling (e.g., associated with second access command signaling) based on received first access command signaling and first data signaling. The interface blocks 245 may accordingly be configured to receive second data signaling, and to write data to one or more memory arrays 250 (e.g., in accordance with an indicated address associated with the first access command signaling) based on the received second access command signaling and second data signaling. In some examples, the interface blocks 220 may include an error control functionality (e.g., error detection circuitry, error correction circuitry, error correction code (ECC) logic, an ECC engine) that supports the interface blocks 220 generating the second data signaling based on performing an error control operation using the received first data signaling (e.g., detecting or correcting an error in the first data signaling, determining one or more parity bits to be conveyed in the second data signaling and written with the data).

In some examples, to support read operations of the system 200, circuitry of the interface blocks 245 may be configured to read data from the memory arrays 250 based on received second access command signaling, and to transmit first data signaling based on the read data. The interface blocks 220 may accordingly be configured to receive first data signaling, and to transmit second data signaling (e.g., to a host processor 210, to a controller 215, to a logic block 225) based on the received first data signaling. In some examples, the interface blocks 220 may include an error control functionality that supports the interface blocks 220 generating the second data signaling based on performing an error control operation using the received first data signaling (e.g., detecting or correcting an error in the first data signaling, which may include a calculation involving one or more parity bits received with the first data signaling).

In some examples, access command signaling that is transmitted to the interface blocks 245, among other signaling, may be generated (e.g., based on access command signaling received from a host processor 210, based on initiation signaling received from a host processor 210, without receiving or otherwise independent from signaling from a host processor 210) in accordance with various determination or generation techniques configured at the interface blocks 220 or the logic blocks 225 (e.g., based on a configuration for accessing memory arrays 250 that is modified at the interface blocks 220 or the logic blocks 225). In some examples, such techniques may involve signaling or other coordination with a logic block 230, a logic block 225, a host processor 210, one or more controllers 215, one or more instances of non-volatile storage, one or more sensors, or any combination thereof. Such techniques may support the interface blocks 220 or logic blocks 225 configuring aspects of the access operations performed on the memory arrays 250 by a respective interface block 245, among other operations. For example, interface blocks 220 or logic blocks 225 may include evaluation circuitry, access configuration circuitry, signaling circuitry, scheduling circuitry, repair circuitry, refresh circuitry, error control circuitry, adverse access (e.g., row hammer) mitigation circuitry, and other circuitry operable to configure operations associated with one or more dies (e.g., operations associated with accessing memory arrays 250 of the dies 240).

In accordance with examples disclosed herein, a system 200 (e.g., one or more logic blocks 225) may support data protection techniques associated with data sets that each include multiple data segments stored across multiple memory arrays 250 and, in some examples, multiple dies 240. For example, as part of a write operation for a first data segment of a data set (e.g., to a first memory array 250, via an interface block 245, via an interface block 220), the system 200 (e.g., a logic block 225) may retrieve the remaining data segments of the data set (e.g., from one or more second memory arrays 250, via one or more other interface blocks 245, via one or more other interface blocks 220) and calculate error correction information using the first data segment and the remaining data segments. Alternatively, the system 200 (e.g., a logic block 225) may not retrieve the remaining data segments of the data set and may instead retrieve and modify the error correction information using the first data segment. As part of a read operation for a second data segment of the data set, the system 200 (e.g., a logic block 225) may retrieve each data segment of the data set (e.g., from a respective memory array 250, via a respective interface block 245, via a respective interface block 220) and perform an error correction operation on the data set using the error correction information. By supporting data protection techniques associated with data sets that are each stored across multiple memory arrays 250 and, in some examples, multiple dies 240, the system 200 (e.g., a logic block 225) may support increased integrity of stored data, increased data correction capabilities, and improved reliability and repair techniques, further improving performance of the system 200 that implements an increased throughput and reduced latency of a stacked memory architecture.

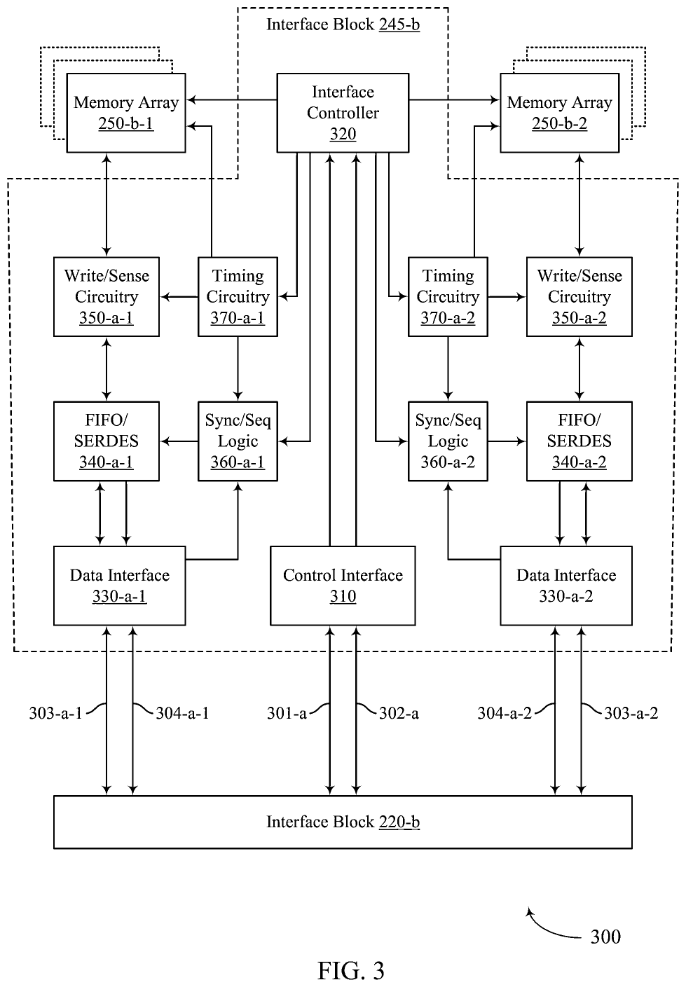

FIG. 3 shows an example of an interface architecture 300 that supports data protection techniques in stacked memory architectures in accordance with examples as disclosed herein. The interface architecture 300 illustrates an example of an interface block 245-b (e.g., of a die 240) coupled with an interface block 220-b (e.g., of a die 205). The interface block 245-b may be communicatively coupled with the interface block 220-b via one or more of a bus 301, a bus 302, a bus 303, and a bus 304, each of which may be examples of one or more signal paths of a bus 221 and a bus 246, as well as a bus 255, where applicable.

The interface block 245-b includes a control interface 310 (e.g., a command interface), which may be configured to communicate signaling with the interface block 220-b. For example, the control interface 310 may include circuitry (e.g., a receiver, one or more latches) configured to receive control signaling (e.g., modulated control signaling, access command signaling, configuration signaling, address signaling, such as row address signaling or column address signaling) via the bus 301-a. The control interface 310 also may include circuitry configured to receive clock signaling (e.g., clock signaling associated with the control interface 310, clock signaling having one or more phases, such as true and complement phases, dk_t/c signaling from the interface block 220-b) via the bus 302-a, which the control interface 310 may use for receiving the control signaling of the bus 301-a (e.g., for triggering the one or more latches). The control interface 310 may transmit (e.g., forward) the control signaling and the clock signaling (e.g., for timing of other operations of the interface block 245-b) to an interface controller 320.

The interface block 245-b also includes two data interfaces 330 (e.g., data interfaces 330-a-1 and 330-a-2), which also may be configured to communicate signaling with the interface block 220-b. Each data interface 330 may include corresponding buses and circuitry, the operation of which may be associated with (e.g., controlled by, coordinated with, operated based on) control signaling via the control interface 310. Although the example of interface block 245-b includes two data interfaces 330 associated with the control interface 310 (e.g., in a “channel pair” arrangement, in a “pseudo-channel pair” arrangement), the described techniques for an interface block 245 may include any quantity of one or more data interfaces 330, and associated buses and circuitry, for a given control interface 310 of the interface block 245.

Each data interface 330 may be associated with respective data path circuitry, which may include respective first-in-first-out (FIFO) and serialization/deserialization (SERDES) circuitry (e.g., FIFO/SERDES 340), respective write/sense circuitry 350, respective synchronization and sequencing circuitry (e.g., sync/seq logic 360), and respective timing circuitry 370, along with interconnecting signal paths (e.g., one or more buses). However, in some other examples, data path circuitry may be arranged in a different manner, or may include different circuitry components, which may include circuitry that is dedicated to respective data paths, or shared among data paths, or various combinations thereof. Each data interface 330 also may be associated with a respective set of one or more memory arrays 250. In some examples, each memory array 250 may be understood to include respective addressing circuitry such as bank logic or decoders (e.g., a row decoder, a column decoder), or memory cell sense amplifier circuitry, among other array circuitry. However, in some other examples, at least a portion of such circuitry may be included in an interface block 245.

Each data interface 330 may include circuitry (e.g., one or more latches, one or more drivers) configured to communicate (e.g., receive, transmit) data signaling (e.g., modulated data signaling, DQ signaling) via a respective bus 303. Each data interface 330 also may include circuitry to communicate clock signaling via a respective bus 304, which may support clock signal reception by the data interface 330 (e.g., first clock signaling associated with the data interface 330, clock signaling having one or more phases, such as true and complement phases, DQS_t/c signaling from the interface block 220-b, clock signaling associated with data reception or write operations), or clock signal transmission by the data interface 330 (e.g., second clock signaling associated with the data interface 330, RDQS_t/c signaling to the interface block 220-b, clock signaling associated with data transmission or read operations), or both. In some examples, a data interface 330, a bus 303, or a combination of a bus 303 and a bus 304, may be associated with a “pseudo-channel,” and multiple pseudo-channels may be associated with the same control interface 310 or the same control bus (e.g., a bus 301, a combination of a bus 301 and a bus 302). In some implementations, pseudo-channels of multiple interface blocks 245 may be grouped together (e.g., functionally, logically, electrically, such as through hard-wired signal paths or multiplexing circuitry) to support a channel set (e.g., associated with a corresponding host interface 216). Each data interface 330 may transmit clock signaling (e.g., received clock signaling, DQS_t/c signaling) to sync/seq logic 360 via a respective bus (e.g., for timing of other operations of the interface block 245-b).

The interface controller 320 may support various functionality (e.g., control functionality, configuration functionality) of the interface block 245-b for accessing or otherwise managing operations of the coupled memory arrays 250. For example, the interface controller 320 may support access command coordination or configuration, latency or timing compensation, access command buffering (e.g., in accordance with a FIFO or other organizational scheme), mode registers or logic for configuration settings, or test functionality (e.g., evaluation functionality, BIST functionality), among other functions or combinations thereof. For each data path of the interface block 245 (e.g., associated with a respective data interface 330), the interface controller 320 may be configured to transmit signaling (e.g., address signaling, such as row address or row activation signaling) to the respective memory arrays 250 via a bus. For each data path of the interface block 245, the interface controller 320 may communicate signaling (e.g., timing signaling, which may be based on clock signaling received from the control interface 310, configuration signaling) with respective timing circuitry 370 and sync/seq logic 360 via respective buses.

For each data path, the respective timing circuitry 370 may support timing of various operations (e.g., activations, coupling operations, signal latching, signal driving) relative to timing signaling received from the interface controller 320. For example, timing circuitry 370 may include a timing chain (e.g., a global column timing chain) configured to generate one or more clock signals or other initiation signals for controlling operations of the respective data path, and such signaling may include transitions (e.g., rising edge transitions, falling edge transitions, on/off transitions) that are offset from, at a different rate from, or otherwise different from transitions of signaling from the interface controller 320 to support a given operation or combination of operations. For example, timing circuitry 370 may be configured to transmit signaling (e.g., address signaling, such as column address or column activation signaling) to the respective memory arrays 250, to transmit signaling to the respective write/sense circuitry 350 (e.g., latch or driver timing signaling), and to transmit signaling to the respective sync/seq logic (e.g., timing signaling).

For each data path, the respective FIFO/SERDES 340 may be configured to convert between data signaling of a first bus width (e.g., a relatively wide bus width, a data read/write (DRW) bus, a bus for communications with write/sense circuitry 350 having a relatively larger quantity of signal paths) and a second bus width (e.g., a relatively narrow bus width, a bus for communications with a data interface 330 having a relatively smaller quantity of signal paths). In some examples, such a conversion may be accompanied by changing a rate of signaling between signaling from the data interface 330 and the write/sense circuitry 350 (e.g., to maintain a given throughput). In various examples, the FIFO/SERDES 340 may receive data signaling from the data interface 330 and transmit data signaling to the write/sense circuitry 350 (e.g., to support a write operation), or may receive data signaling from the sense circuitry 350 and transmit data signaling to the data interface 330 (e.g., to support a read operation). In some examples (e.g., to support a read operation), the FIFO/SERDES 340 may be configured to transmit clock signaling (e.g., RDQS_t/c signaling) to the data interface 330, which may be forwarded to the interface block 220-b.

The timing or other synchronization of operations performed by the FIFO/SERDES 340 may be supported by one or more clock signals, among other signaling, received from the respective sync/seq logic 360. For example, the sync/seq logic 360 may generate or otherwise coordinate clock signaling to support the different rates of signaling of different buses (e.g., based on received clock signaling). Additionally, or alternatively, the FIFO/SERDES 340 may operate in a direction (e.g., for data transmission to a data interface 330, for data reception from a data interface 330) or other mode based on configuration signaling received from the sync/seq logic 360.

For each data path, the respective write/sense circuitry 350 may be configured to support the accessing (e.g., data signaling, write signaling, read signaling) of the respective set of one or more memory arrays 250. For example, the write/sense circuitry 350 may be coupled with the memory arrays 250 via a bus (e.g., a global input/output (GIO) bus), which may include respective signal paths associated with each memory array 250, or may include signal paths that are shared for all of the memory arrays 250 of the set, in which case the memory array circuitry may include multiplexing circuitry operable to couple the bus with a selected one of the memory arrays 250. In some examples, a bus between the write/sense circuitry 350 and the set of one or more memory arrays 250 may include a same quantity of signal paths as a bus between the write/sense circuitry 350 and the FIFO/SERDES 340 (e.g., for signaling GIO[287:0]) or a same quantity of signal paths as a quantity of columns in each memory array 250. In some other examples, the memory arrays 250 may include a quantity of columns that is an integer multiple of the quantity of signal paths of the bus, in which case the memory array circuitry (e.g., each memory array 250) may include decoding circuitry operable to couple a subset of columns of memory cells, or associated circuitry, with the bus.

To support write operations, the write/sense circuitry 350 may be configured to drive signaling that is operable to write one or more logic states to memory cells of the memory arrays 250 (e.g., based on received data, based on received timing signaling, based on data signaling received via a bus 303 and on control signaling received via a bus 301-a). In some examples, such signaling may be transmitted to supporting circuitry of or otherwise associated with the memory arrays 250 (e.g., as an output of signals corresponding to logic states to be written), such as sense amplifier circuitry, voltage sources, current sources, or other driver circuitry operable to apply a bias across a storage element of the memory cells (e.g., across a capacitor, across a ferroelectric capacitor), or apply a charge, a current, or other signaling to a storage element of the memory cells (e.g., to apply a current to a chalcogenide or other configurable memory material, to apply a charge to a gate of a NAND memory cell), among other examples.

To support read operations, the write/sense circuitry 350 may be configured to receive signaling that the write/sense circuitry 350 may further amplify for communication through the interface block 245-b. For example, the write/sense circuitry 350 may be configured to receive signaling corresponding to logic states read from the memory arrays 250, but at a relatively low driver strength (e.g., relatively ‘analog’ signaling, which may be associated with a relatively low drive strength of sense amplifiers of the memory arrays 250). The write/sense circuitry 350 may thus include further sense amplification (e.g., a data sense amplifier (DSA) between signal paths between the write/sense circuitry and the set of one or more memory arrays and respective signal paths between the write/sense circuitry and the FIFO/SERDES), which each may have a relatively high drive strength (e.g., for driving relatively ‘digital’ signaling).

The features of the interface architecture 300 may be duplicated in various quantities and arrangements to support a semiconductor system having multiple dies, such as various examples of a system 200. In an example implementation, each die 240 may be configured with 64 instances of the interface block 245-b, which may support a data signaling width of 9,216 signal paths for each die 240 (e.g., where each bus 303 of a channel pair is associated with 72 signal paths). For a system 200 having a stack of eight dies 240 coupled with a die 205, the die 205 may thus be configured with 512 instances of the interface block 220-b, thereby supporting an overall data signaling width of 73,738 signal paths for the system 200. However, in other implementations, dies 205 and dies 240 may be configured with different quantities of interface blocks 220 and 245, respectively, and a system 200 may be configured with different quantities of dies 240 per die 205.

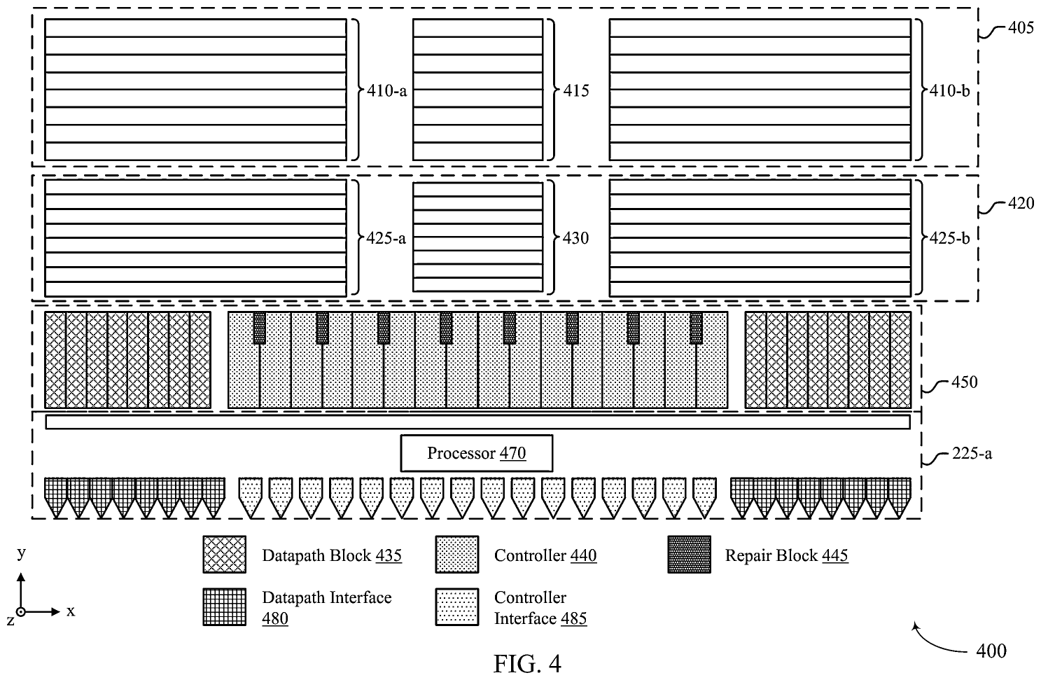

FIG. 4 shows an example of an interface architecture 400 that supports data protection techniques in stacked memory architectures in accordance with examples as disclosed herein. The interface architecture 400 may illustrate aspects of an interface between a host interface 216 (e.g., a controller 215, a host processor 210) and a corresponding set of multiple memory arrays 250, such as an interface between a host interface 216 and a set of multiple interface blocks 245 (e.g., via a logic block 225-a, via one or more interface blocks 220), an interface between a host interface 216 and a set of multiple dies 240 (e.g., stacked along the z-direction), or both, among other architectures. For example, the set of multiple memory arrays 250 supported by the interface architecture 400 may be located in a single die 240 or multiple dies 240 (e.g., a respective die 240 for each memory array 250, a respective die 240 for a subset of multiple memory arrays 250). In various examples, one or more instances of the interface architecture 400 may be implemented in a die 205 (e.g., multiple instances of the interface architecture 400 tiled along the x-direction, along the y-direction, or both).

The interface architecture 400 may include a section 405 corresponding to a set of contacts 410 and a set of contacts 415 (e.g., ports, interfaces) for through-silicon-vias (TSVs) associated with accessing memory arrays 250 of a set of one or more dies 240. In some examples, contacts of a set of contacts 410, of a set of contacts 415, or both may be examples of or be otherwise associated with contacts 222. For example, the section 405 may include a set of contacts 410-a for TSVs corresponding to accessing a first subset of memory arrays 250 (e.g., corresponding to a set of interface blocks 245, of one or more dies 240), and may include a set of contacts 410-b for TSVs corresponding to accessing a second subset of memory arrays 250 (e.g., corresponding to a set of interface blocks 245, of the one or more dies 240, which may be the same as or different from the set of interface blocks 245 associated with the set of contacts 410-a). Each set of contacts 410 may be arranged as one or more rows of contacts. For example, the set of contacts 410-a may include eight rows of contacts (e.g., to support a stack of eight dies 240), and each row of contacts may correspond to a respective set of one or more memory arrays 250 (e.g., an interface block 245 of a respective die 240). In some examples, each row of contacts of a set of contacts 410 may be associated with a bus 303, a bus 304, or a combination thereof (e.g., of a pseudo-channel).

The section 405 also may include a set of contacts 415, which may include one or more rows of control contacts (e.g., rows of control ports) associated with command or other control signaling for accessing the set of memory arrays 250 associated with the interface architecture 400. For example, the set of contacts 415 may also include eight rows of contacts (e.g., to support the stack of eight dies 240), and each row of contacts may correspond to a respective interface block 245 (e.g., a respective control interface 310). In some examples, each row of contacts of the set of contacts 415 may be associated with a bus 301, a bus 302, or a combination thereof.

In some examples, the set of contacts 410-a and the set of contacts 410-b may be arranged on either side of the set of contacts 415, which may allow for each row of command contacts of the set of contacts 415 to correspond to two pseudo-channels (e.g., two buses 303, two buses 304, or both), one for each subset of memory arrays 250. A quantity of contacts per set of contacts 410 or per set of contacts 415, or row or other portion thereof, may be variable, however, and may be adjusted based on a quantity of memory arrays 250 or dies 240 to be supported by the interface architecture 400, among other aspects.

The interface architecture 400 may include a section 420, which may include drivers (e.g., transmitter circuitry, receiver circuitry, interfaces, ports) operable to communicate read data, write data, and commands to and from the set of dies 240 via the contacts of the section 405. For example, the set of contacts 410-a and the set of contacts 410-b may be coupled with a set of drivers 425-a and a set of drivers 425-b, respectively. Similarly, the set of contacts 415 may be coupled with a set of drivers 430, and the set of drivers 430 may include one or more rows of command drivers (e.g., command ports).

In some examples, interface architecture 400 may include a set of datapath blocks 435 corresponding to the set of memory arrays 250 (e.g., corresponding to a set of interface blocks 245, corresponding to the set of dies 240). Each datapath block 435 may receive data directed from or to a respective memory array 250 of the set of memory arrays 250 (e.g., from the set of one or more dies 240). The datapath blocks 435 may be arranged such that a first subset of the datapath blocks 435 corresponding to the first subset of memory arrays 250 is located in a first area of a section 450 of the interface architecture 400, and a second subset of the datapath blocks 435 corresponding to the second subset of memory arrays 250 is located in a second area of the section 450, as illustrated. This may support routing between datapath blocks 435 and corresponding rows of drivers of the set of drivers 425-a and the set of drivers 425-b. In some examples, a subset of one or more of the datapath blocks 435 (e.g., a pair of datapath blocks 435, in a pseudo-channel pair arrangement) may each be included in or be otherwise associated with a respective interface block 220.

In some cases, datapath blocks 435 may each be configured to perform error control operation for a corresponding subset of one or more memory arrays 250 (e.g., for a corresponding die 240, for a corresponding interface block 245). For example, each datapath block 435 may be configured to generate an error correction code (ECC) and execute an error control operation using the ECC on a corresponding die 240. The ECC generated by a datapath block 435 may be stored with data (e.g., in a same memory array 250, in a different memory array 250, in the same die 240, in a different die 240). A datapath block 435 may execute an ECC process for read operations to check the data read from a memory array 250 using the associated ECC and detect or correct (or both) one or more errors before outputting the data (e.g., to the logic block 225-a, to a host interface 216, to a controller 215, to a host processor 210) from the datapath block 435.

In some examples, the interface architecture 400 may include a set of controllers 440 associated with receiving commands from a host system 105 (e.g., from a host processor 210, from a controller 215, via a host interface 216, via the logic block 225-a) and performing control operations. For example, the controllers 440 may support scheduling across memory banks, such as scheduling row and column commands, monitoring timings associated with the plurality of dies 240 (e.g., DRAM timings, column address strobe (CAS) timings), mapping logical addresses to physical addresses associated with the set of dies 240 (e.g., a set of one or more memory arrays 250), performing column repair and row repair procedures, or any combination thereof. In some examples, the interface architecture 400 may include a controller 440 for each of a set of interface blocks 245, which may be on the same die 240 or on multiple dies 240 (e.g., respective dies 240). Controllers 440 may be located within the section 450, between the first subset of the datapath blocks 435 corresponding to the first subset of memory arrays 250 and the second subset of the datapath blocks 435 corresponding to the second subset of memory arrays 250. In some examples, each of the controllers 440 may be included in or be otherwise associated with a respective interface block 220 (e.g., a same interface block 220 as a pair of the datapath blocks 435 in a pseudo-channel pair arrangement).

In some examples, the interface architecture 400 may include a set of repair blocks 445, which may each be common to and shared by a set of multiple controllers 440. For example, a single repair block 445 may be associated with performing repair operations (e.g., column repair and row repair operations, for a pair of interface blocks 245, for a pair of dies 240) that correspond to the pair of controllers 440. In some cases, the set of repair blocks 445 may be configured to perform address swapping based on repair data received from non-volatile storage 235 or non-volatile storage 270. A repair block 445 may, in some examples, store repair data received in a memory array (e.g., a volatile memory array, such as SRAM array) of the repair block 445. By sharing repair blocks 445 between pairs of controllers 440, the interface architecture 400 may be smaller in size, such as by decreasing the quantity repair blocks 445 and memory arrays 250 associated with the repair blocks 445.

The datapath blocks 435 and the controllers 440 may be coupled with the logic block 225-a in accordance with various arrangements. For example, each coupling of the logic block 225-a with a pair of datapath blocks 435 and a corresponding controller 440 (e.g., in accordance with a pseudo-channel pair arrangement) may be an example of a bus 223. The interface architecture 400 (e.g., the logic block 225-a) may also include a set of datapath interfaces 480 and a set of controller interfaces 485 that support interfacing with (e.g., receiving and sending data and commands to) a host interface 216 (e.g., a controller 215, a host processor 210, a host system 105). For example, the datapath interfaces 480 may support receiving data or sending data via a host interface 416, and the command interfaces 485 may support receiving commands from the host interface 416. In some examples, the datapath interfaces 480 and the controller interfaces 485 may each be examples of one or more conductive channels (e.g., conductors, terminals, pins, pads, nodes) associated with a host interface 216, and may support coupling the interface architecture 400 with a controller 215 (e.g., of a die 205, external to a die 205).

In some examples, each datapath interface 480 may be coupled with a respective datapath block 435, and each controller interface 485 may be coupled with a respective controller 440. In some cases, the datapath blocks 435 and the controllers 440 may receive or send data and commands to or from the datapath interfaces 480 and the controller interfaces 485 via a set of multiplexers 465 (e.g., of the logic block 225-a). For example, the set of multiplexers 465 may be operable to route incoming or outgoing data from a datapath interface 480 to a corresponding datapath block 435 and may be operable to route incoming commands from a controller interface 485 to a corresponding controller 440.

The interface architecture 400 (e.g., the logic block 225-a) may include a processor 470 (e.g., processing circuitry, logic circuitry, one or more processing elements) that supports various functionality to control or coordinate aspects of a system 200 (e.g., aspects of operations of or using multiple interface blocks 220). For example, a processor 470 may be an example of or otherwise implement circuitry that supports functions such as logic, multiplexing, configuration, evaluation, repair, error control, or any combination thereof (e.g., by way of hardware configuration, by way of instruction configuration). In some examples, a processor 470 may be coupled with each of the controllers 440 and may be operable to perform procedures to test aspects of operating dies 240 (e.g., through a corresponding controller 440) by issuing commands associated with a test procedure (e.g., performed during manufacturing testing). In some examples, a processor 470 may additionally, or alternatively, initiate or aid in performing row repair procedures and column repair procedures (e.g., via the repair blocks 445), such as by storing or providing logic associated with row repair and column repair procedures. In some examples, a processor 470 may receive repair data from non-volatile storage 235 or non-volatile storage 270 and may initiate row repair procedures or column repair procedures (e.g., via a corresponding repair block 445) based on the repair data.

In some cases, each datapath interface 480 or corresponding datapath block 435 may form one or more respective conductive paths (e.g., of a channel, of a pseudo-channel), and may each be operable to independently communicate data according to a data size (e.g., 32 bytes, via any quantity of one or more signal paths). For example, the interface architecture 400 may transmit a data set associated with read operation over a single datapath block 435 and a datapath interface 480 using a series of data segments of the data size. Additionally, or alternatively, the interface architecture 400 may transmit multiple data segments of the data set (e.g., in parallel) by transmitting each data segment using a respective datapath block 435 and corresponding datapath interface 480. To support the concurrent transfer of data segments, the data set may be stored across a set of memory arrays 250 (e.g., across a set of dies 240), such that each data segment is stored in a respective memory array 250 (e.g., the data set may be striped across multiple memory arrays 250, which may include being striped across multiple dies 240).

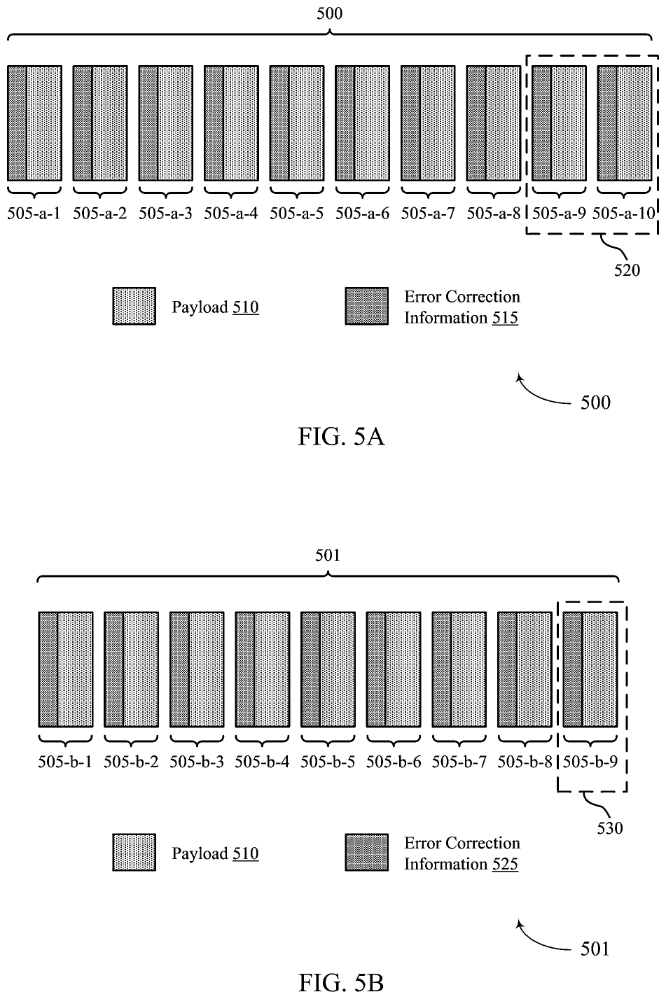

FIG. 5A shows an example of a data set 500 that supports data protection techniques in stacked memory architectures in accordance with examples as disclosed herein. The data set 500 may illustrate an example of data communicated between a host system 105 and a memory system 110 (e.g., a 3D stacked memory system) in a multi-channel ECC configuration. For example, the data set 500 may include multiple data segments 505-a communicated over a set of conductive paths (e.g., channels, pseudo-channels). In various examples, the data set 500 may refer to the collective set of payload 510 of at least some of (e.g., each of) the data segments 505-a or, where applicable, the collective set of payload 510 and error correction information 515 of at least some of (e.g., each of) the data segments 505-a. In an illustrative example, the payload 510 of a data segment 505-a may be 32 bytes, but any size of payload 510 or data segment 505-a may be implemented in the described techniques.

In some cases, a memory system 110 (e.g., a logic block 225) may communicate each of the data segments 505-a concurrently over a respective conductive path (e.g., of a bus 251, of a bus 246, of a bus 221, of a bus 223). For example, a memory system 110 may store the data set 500 across a set of memory arrays 250 arranged on one or more dies 240. In some cases, a memory system 110 may store each data segment 505-a of the data set 500 at a separate memory array 250, at a separate die 240, or both (e.g., the data set 500 may be striped across pseudo-channels of the memory system 110). In some implementations, the memory system 110 may include a set of interface blocks 220 arranged on a die 205, which may support communication of the data segments 505-a between respective memory arrays 250 and a separate component, such as a host system 105 (e.g., a controller 215, a host processor 210).

In some examples, each interface block 220 may couple with a respective die 240 and a respective set of one or more memory arrays 250 (e.g., coupled with an interface block 245 of a die 240). A logic block 225 associated with the die 205 may support accessing the data segments 505-a of the data set 500 across the set of dies 240 as part of an access command, such as a read command or a write command for the data set. Each interface block 220 may be configured (e.g., by the logic block 225) to retrieve (e.g., in the case of a read command) or transmit (e.g., in the case of a write command) a respective data segment 505-a of the data set 500 from or to a corresponding memory array 250 of a respective die 240 (e.g., via a respective interface block 245).

In some examples, the die 205 (e.g., a logic block 225) may include a set of datapath blocks 435, each datapath block 435 operable to communicate data with a respective interface block 245, a respective die 240, or both. Accordingly, the memory system 110 may support independent access of data segments 505-a via each interface block 245 or die 240 (e.g., via a datapath block 435, using a logic block 225). For example, as part of an access operation for a data segment 505-a, an interface block 220 may communicate the data segment 505-a with a corresponding interface block 245 using a channel between the interface block 220 and the interface block 245 (e.g., a bus 303). Additionally, or alternatively, the memory system 110 (e.g., a logic block 225) may communicate multiple data segments 505-a of the data set 500 (e.g., in parallel, concurrently) by communicating each data segment 505-a using a respective interface block 220 and a respective interface block 245 (e.g., to a respective die 240).

To support data integrity of the data set 500 stored across multiple memory arrays 250, one or more data segments 505-a (e.g., data segments 505-a-9 and 505-a-10 which may, alternatively, be referred to as error control segments) of the data set 500 may include or be otherwise associated with error correction information 520 corresponding to the data set 500 (e.g., parity information, parity bits, set-level error correction information, stripe-level error correction information). The error correction information 520 may support correcting a failure of, for example, an entire data segment 505-a of the data set 500, or at least the payload 510 thereof (e.g., failure of a memory array 250, failure of a die 240, or failure of one or more associated buses, a single 32-byte read failure). A memory system 110 (e.g., a logic block 225, a processor 470) may generate or update the error correction information 520 for a data set 500 as part of a write operation for any one or more of the data segments 505-a of the data set 500 and may use the error correction information 520 to detect or correct (or both) one or more errors within the data set 500 as part of a read operation for one or more data segment 505-a. In some examples, such techniques may implement ten dies 240 to provide a full address space for such a solution, with ten associated pseudo-channels being associated with a same vault.

In some cases, a memory system 110 (e.g., a logic block 225, a processor 470) may store error correction information 520 at one or more dies 240 separately from other portions of the data set 500. For example, a memory system 110 may include a first quantity of dies 240 (e.g., eight dies 240) allocated to storing data (e.g., data segments 505-a-1 through 505-a-8) of the data set 500 and may include a second quantity of dies 240 (e.g., two dies 240) allocated to storing the error correction information 520 of the data set 500. In such examples, the memory system 110 may store each data segment 505-a at a respective die 240, and the error correction information 520 may remain in the same allocated dies 240 or may be rotated among the dies 240. Additionally, or alternatively, a memory system 110 may distribute data of the data set 500 and the error correction information 520 of the data set 500 across each of the dies 240 (e.g., across ten dies). In such examples, the error correction information 520 may include a set of portions, each portion stored at a respective die 240. In various other examples, a memory system 110 may distribute a data set 500 across more than ten dies 240 or fewer than ten dies 240.

In some examples, a memory system 110 may receive (e.g., at a logic block 225), a write command to store a data segment 505-a to a die 240. In some cases, the write command may indicate that the data segment 505-a is part of a data set 500. Additionally, or alternatively, the memory system 110 (e.g., the logic block 225, a processor 470) may associate the data segment 505-a with a data set 500 based on metadata associated with the data segment 505-a, such as an address of the data segment 505-a. In some examples, each data segment 505-a may be stored to a same address, or portion thereof (e.g., a same bank address, row address, column address, or combination thereof) within the respective memory arrays 250, which may support efficient access of the data set 500.

As part of a write operation, a memory system 110 (e.g., a logic block 225, a processor 470) may retrieve each data segment 505-a of the associated data set 500 from a respective memory array 250 of the dies 240 (e.g., via a respective interface block 245, via a respective interface block 220, via a respective datapath block 435) and may add the data segment 505-a to the data set 500 (e.g., by overwriting or modifying a data segment 505-a stored to a memory array 250 indicated by the write command). The memory system 110 (e.g., the logic block 225, the processor 470) may generate the error correction information 520 using each data segment 505-a of the data set 500. For example, the logic block 225 may perform an error control operation on the data set 500 to calculate the error correction information 520. The memory system 110 (e.g., the logic block 225) may store the data set 500, including the generated error correction information 520, to the set of memory arrays 250 (e.g., to the set of dies 240). For example, the memory system 110 may transmit each data segment 505-a of the data set 500 to the respective memory array 250 of one or more dies 240 (e.g., via the respective interface blocks 245, via the respective interface blocks 220).

Additionally, or alternatively, as part of a read operation to retrieve a data segment 505-a of a data set 500 from a set of memory arrays 250, a memory system 110 may receive (e.g., at a logic block 225) a read command to retrieve the data segment 505-a. In some cases, the read command may indicate that the data segment 505-a is part of a data set 500. Additionally, or alternatively, the memory system 110 (e.g., the logic block 225) may determine that the data segment 505-a is associated with a data set 500 based on metadata associated with the data segment 505-a, such as an address of the data segment 505-a.

As part of the read operation, the memory system 110 (e.g., the logic block 225) may retrieve each data segment 505-a of the associated data set 500, along with the error correction information 520 corresponding to the data set 500, from respective memory arrays 250 of the one or more dies 240 (e.g., via a respective interface block 245, via a respective interface block 220). The memory system 110 (e.g., the logic block 225, a processor 470) may perform an error control operation on the data set 500 (e.g., a set-level error detection operation, a set-level error correction operation) using the error correction information 520 to correct or detect (or both) one or more errors within the data set 500. The memory system 110 (e.g., the logic block 225) may output the data segment 505-a (e.g., over a host interface 216, to a controller 215, to a host processor 210, to a host system 105).

In some examples, a memory system 110 may employ a hierarchy of error control techniques to support integrity of the data set 500. For example, as part of a write operation for a data segment 505-a, the memory system 110 (e.g., a logic block 225, a processor 470, an interface block 220) may generate error correction information 515 (e.g., segment-level error control information) for a payload 510 of the data segment 505-a, and may store the error correction information 515 with the payload 510 of the data segment 505-a. As part of a read operation for a data segment 505-a, the memory system 110 (e.g., the logic block 225, the processor 470, the interface block 220) may retrieve the error correction information 515 associated with the payload 510 of the data segment 505-a. The memory system 110 (e.g., the logic block 225, the processor 470, the interface block 220) may perform an error control operation (e.g., a segment-level error detection operation, a segment-level error correction operation) on the payload 510 using the error correction information 515, and may output at least the payload 510 of the data segment 505 (e.g., to the logic block 225, or a portion thereof, for output to a host interface 216). In some cases, error correction information 515 may be associated with an ECC scheme, such as a single error correction double error detection (SECDED) scheme or a double error correction triple error detection (DECTED) scheme operable for each data segment 505-a. In some such examples, the error control operation associated with the data segment 505-a may be followed by an error control operation associated with the data set 500 (e.g., a set-level error detection operation, a set-level error correction operation) using the error correction information 520. In some other examples, error correction information 515 may be omitted from data segments 505-a (e.g., omitting segment-level error control operations), such that data segments 505-a may include payload 510 only.

In some examples, using the error correction information 520 to detect and correct errors within the data set 500 may support increased data integrity, but may be associated with a relatively larger power and performance penalty. For example, because the error correction information 520 is generated using all of the data segments 505-a of a data set 500, a read operation or write operation for a single data segment 505-a of the data set 500 may include the memory system 110 (e.g., a logic block 225, a processor 470) retrieving each data segment 505-a of the data set 500 to perform the error correction operation using the error correction information 520. Accordingly, such an approach may be associated with a relatively large minimum access size (e.g., a minimum access of 256 bytes of payload 510 striped across 8 memory arrays 250). Furthermore, because each memory array 250 (e.g., each die 240, each interface block 245) may support a relatively large page size compared with the size of a data segment 505-a (e.g., a 5 kilobyte page size relative to a 32 byte data segment), retrieving each data segment 505-a of a data set 500 may result in a relatively large access operation for memory array 250.

FIG. 5B shows an example of a data set 501 that supports data protection techniques in stacked memory architectures in accordance with examples as disclosed herein. The data set 501 may illustrate an example of data communicated between a host system 105 and a memory system 110 (e.g., a 3D stacked memory system) in a multi-channel redundant array of independent disks (RAID) configuration. For example, the data set 501 may include multiple data segments 505-b communicated over a set of conductive paths (e.g., channels, pseudo-channels). In various examples, the data set 501 may refer to the collective set of payload 510 of at least some of (e.g., each of) the data segments 505-b or, where applicable, the collective set of payload 510 and error correction information 525 of at least some of (e.g., each of) the data segments 505-b. In an illustrative example, the payload 510 of a data segment 505-b may be 32 bytes, but any size of payload 510 or data segment 505-b may be implemented in the described techniques.

Like the examples of data sets 500, in some cases, a memory system 110 may communicate each of the data segments 505-b concurrently over a respective conductive path. For example, a memory system 110 may store the data set 501 across a set of memory arrays 250 arranged on one or more dies 240. In some cases, a memory system 110 may store each data segment 505-b of the data set 501 at a separate memory array 250, at a separate die 240, or both (e.g., the data set 501 may be striped across pseudo-channels of the memory system 110). In some implementations, the memory system 110 may include a set of interface blocks 220 arranged on a die 205, which may support communication of the data segments 505-b between respective memory arrays 250 and a separate component, such as a host system 105.

In some examples, a logic block 225 associated with a die 205 may support accessing the data segments 505-b of the data set 501 across a set of dies 240 as part of an access command, such as a read command or a write command for the data set. Each interface block 220 may be configured to retrieve (e.g., in the case of a read command) or transmit (e.g., in the case of a write command) a respective data segment 505-b of the data set 501 from or to a corresponding memory array 250 of a respective die 240. In some examples, a memory system 110 may support independent access of data segments 505-b via each interface block 245 or die 240 (e.g., via a datapath block 435, using a logic block 225). For example, as part of an access operation for a data segment 505-b, an interface block 220 may communicate the data segment 505-b with a corresponding interface block 245 using a channel between the interface block 220 and the interface block 245. Additionally, or alternatively, the memory system 110 may communicate multiple data segments 505-b of the data set 501 by communicating each data segment 505-b using a respective interface block 220 and a respective interface block 245 (e.g., to a respective die 240).

To support data integrity of the data set 501 stored across multiple memory arrays 250 (e.g., across multiple dies 240), one or more data segments 505-b (e.g., data segment 505-b-9 which may, alternatively, be referred to as an error control segment) of the data set 501 may include or be otherwise associated with error correction information 530 corresponding to the data set 501 (e.g., parity information, parity bits, set-level error correction information, stripe-level error correction information). The error correction information 530 may support correcting a failure of, for example, an entire data segment 505-b of the data set 501, or at least the payload 510 thereof (e.g., failure of a memory array 250, failure of a die 240, or failure of one or more associated buses, a single 32-byte read failure). For example, a data protection scheme implemented for the data set 501 may be an example of or may be similar to a RAID scheme, and the error correction information 530 may be calculated using all of the data segments 505-b of the data set 501. In such an example, the error correction information 530 may be the result of a logical operation, such as an Exclusive-OR (XOR) operation, performed across each data segment 505-b. Accordingly, if any data segment 505-b of the data set 501 becomes corrupted, the data segment 505-b may be recovered by performing the logical operation across each of the other data segments 505-b and the error correction information 530. In some examples, such techniques may implement nine dies 240 to provide a full address space for such a solution, with nine associated pseudo-channels being associated with a same vault.

In some cases, a memory system 110 may store error correction information 530 at one or more dies 240 separately from other portions of the data set 501. For example, a memory system 110 may include a first quantity of dies 240 (e.g., eight dies 240) allocated to storing data (e.g., data segments 505-b-1 through 505-b-8) of the data set 501 and may include a second quantity of dies 240 (e.g., one die 240) allocated to storing the error correction information 530 of the data set 501. In such examples, the memory system 110 may store each data segment 505-b at a respective die 240, and the error correction information 530 may remain in the same allocated dies 240 or may be rotated among the dies 240.

In some examples, a memory system 110 may receive (e.g., at a logic block), a write command to store a data segment 505-b (e.g., a “new” data segment 505-b) to a die 240. In some cases, the write command may indicate that the new data segment 505-b is part of the data set 501. Additionally, or alternatively, the memory system 110 may associate the new data segment 505-b with the data set 501 based on metadata associated with the new data segment 505-b, such as an address of the new data segment 505-b. In some examples, each data segment 505-b of a data set 501 may be stored to a same address, or portion thereof (e.g., a same bank address, row address, column address, or combination thereof) within the respective memory arrays, which may support efficient access of the data set 501.

As part of the write operation, a memory system 110 (e.g., a logic block 225, a processor 470) may retrieve the error correction information 530 and, in some cases, may retrieve a data segment 505-b stored at the address included in the write command (e.g., an “old” data segment 505-b). The memory system 110 may modify the error correction information 530 using the new data segment 505-b of the write command and the old data segment 505-b (e.g., in a read-modify-write (RMW) scheme). For example, the memory system 110 may perform a logical function to calculate updated error correction information 530 (e.g., by “XORing out” the old data segment 505-b and “XORing in” the new data segment 505-b). Alternatively, the memory system 110 may retrieve each data segment 505-b associated with the data set 501, and may calculate the updated error correction information 530 using each data segment 505-b. The memory system 110 may modify the data set 501 to include the new data segment 505-b. For example, the memory system 110 may store the new data segment 505-b and the updated error correction information 530, to the set of memory arrays 250 (e.g., of the set of dies 240). For example, the memory system 110 may transmit the new data segment 505-b to a first die 240 (e.g., via a first interface block 245, via a first interface block 220, via a first datapath block 435) and may transmit the error correction information 530 to a second die 240 (e.g., via a second interface block 245, via a second interface block 220, via a second datapath block 435).

In some cases (e.g., for implementing a hierarchy of error control techniques), a memory system 110 (e.g., an interface block 220, a logic block 225, a processor 470) may generate error correction information 525 (e.g., one or more parity bits, one or more CRC bits) for a payload 510 (e.g., of the new data segment 505-b). For example, error correction information 525 may be associated with an error control scheme configured to detect and, in some cases, correct one or more errors within the payload 510 (e.g., for segment-level error detection, for segment-level error correction). For example, the one or more bits of error correction information 525 may be implemented in a cyclic redundancy check (CRC) scheme. In such cases, the memory system 110 (e.g., an interface block 220, a logic block 225, a processor 470) may store the error correction information 525 along with the payload 510 as part of storing a new data segment 505-b.

Additionally, or alternatively, as part of a read operation to retrieve a data segment 505-b of a data set 501 from a set of memory arrays 250, a memory system may receive (e.g., at a logic block 225) a read command to retrieve the data segment 505-b. In some cases, the read command may indicate that the data segment 505-b is part of a data set 501. Additionally, or alternatively, the memory system 110 may determine that the data segment 505-b is associated with the data set 501 based on metadata associated with the data segment 505-b, such as an address of the second data segment 505-b.

As part of the read operation, the memory system 110 may retrieve (e.g., via an interface block 245, via an interface block 220, via a datapath block 435) the data segment 505-b, and may perform an error control operation on the data segment 505-b using the error correction information 525 included in the data segment 505-b. If the memory system 110 (e.g., the interface block 220, the logic block 225, the processor 470) does not detect an error in the data segment 505-b (e.g., in the payload 510), or if the memory system 110 (e.g., the interface block 220, the logic block 225, the processor 470) corrects an error within the data segment 505-b (e.g., in the payload 510), the memory system 110 may output at least the payload 510 of the data segment 505-b (e.g., via the logic block 225, via a host interface 216) without retrieving each of the other data segments 505-b of the data set 501. That is, the memory system may suppress retrieving the data set 501 in its entirety (e.g., suppressing retrieval of other data segments 525-b).

Alternatively, if the memory system 110 detects an error within a data segment 505-b, the memory system 110 may retrieve each data segment 505-b of the associated data set 501, along with the error correction information 530 corresponding to the data set 501, from respective memory arrays 250 (e.g., via respective interface blocks 245, via respective interface blocks 220). The memory system 110 (e.g., a logic block 225, a processor 470) may correct the error, for example by performing a XOR operation on the other data segments 505-b of the data set 501 and the error correction information 530 to recover or recreate the data segment 505-b with the detected error. The memory system 110 (e.g., the logic block 225) may output the data segment 505-b (e.g., over a host interface 216, to a controller 215, to a host processor 210, to a host system 105).

In some cases, the memory system 110 (e.g., the logic block 225) may migrate the error correction information 530 between different memory arrays 250 (e.g., between different dies 240). For example, because the error correction information 530 may be accessed relatively more frequently than each data segment 505-b of a data set 501 (e.g., due to the error correction information 530 being accessed for each write operation associated with the data set 501), the memory system 110 may mitigate hot spots by transferring the error correction information 530 from a first memory array 250 (e.g., of a first die 240) to a second memory array 250 (e.g., of a second die 240).

Using the error correction information 530 to correct errors within a data set 501 may support increased data integrity and may be associated with a relatively lower power and performance penalty (e.g., compared with using the error correction information 520). For example, because the error correction information 530 may be modified using a “new” data segment 505-b and an “old” date segment 505-b, a write operation for a single data segment 505-b of a data set 501 may not involve the memory system 110 retrieving each data segment 505-b of the data set 501 to update the error correction information 530.

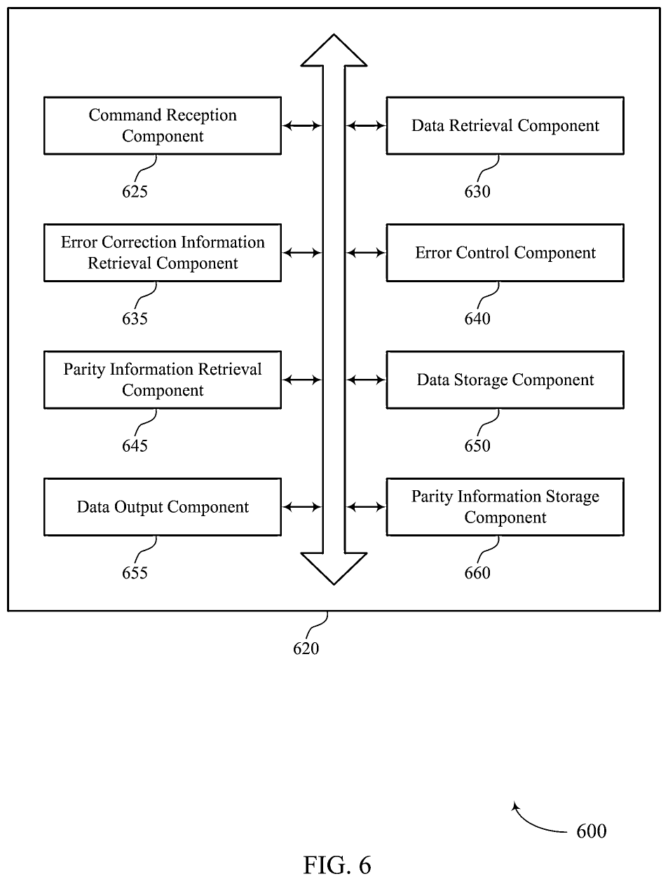

FIG. 6 shows a block diagram 600 of a logic block 620 that supports data protection techniques in stacked memory architectures in accordance with examples as disclosed herein. The logic block 620 may be an example of aspects of a logic block as described with reference to FIGS. 1 through 5B (e.g., a logic block 225, logic of an interface block 220, or a combination thereof). The logic block 620, or various components thereof, may be an example of means for performing various aspects of data protection techniques in stacked memory architectures as described herein. For example, the logic block 620 may include a command reception component 625, a data retrieval component 630, an error correction information retrieval component 635, an error control component 640, a parity information retrieval component 645, a data storage component 650, a data output component 655, a parity information storage component 660, or any combination thereof. Each of these components, or components of subcomponents thereof (e.g., one or more processors, one or more memories), may communicate, directly or indirectly, with one another (e.g., via one or more buses).

In some examples, the command reception component 625 may be configured as or otherwise support a means for receiving, at a logic block of a first semiconductor die of a semiconductor system (e.g., from a controller 215, from a host processor 210), a command to read a data segment stored at the semiconductor system, the semiconductor system including a plurality of memory arrays (e.g., memory arrays 250) of a set of one or more second semiconductor dies (e.g., dies 240) coupled with the first semiconductor die (e.g., a die 205). The data retrieval component 630 may be configured as or otherwise support a means for retrieving, at the logic block based on receiving the command (e.g., via one or more interface blocks 245, via one or more interface blocks 220), a plurality of data segments of a data set that includes the data segment, each of the plurality of data segments retrieved from a respective first memory array of the plurality of memory arrays. The error correction information retrieval component 635 may be configured as or otherwise support a means for retrieving, at the logic block based on receiving the command (e.g., via one or more interface blocks 245, via one or more interface blocks 220), error correction information associated with the data set, the error correction information retrieved from one or more respective second memory arrays of the plurality of memory arrays. The error control component 640 may be configured as or otherwise support a means for performing, at the logic block, an error control operation on the data set based on the error correction information.

In some examples, the error correction information retrieval component 635 may be configured as or otherwise support a means for retrieving second error control information associated with the data segment from the respective first memory array of the plurality of memory arrays (e.g., via one or more interface blocks 245, via one or more interface blocks 220). In some examples, the error control component 640 may be configured as or otherwise support a means for performing a second error control operation on the data segment (e.g., at a logic block 225, at an interface block 220) based on second error control information associated with the data segment based on retrieving the data segment.

In some examples, the error correction information includes a plurality of portions, and each portion of the plurality of portions is stored at a respective second semiconductor die of the set of one or more second semiconductor dies.

In some examples, each of the plurality of data segments is stored at a respective second semiconductor die of the set of one or more second semiconductor dies.

In some examples, the data output component 655 may be configured as or otherwise support a means for outputting the data segment from the logic block based on performing the error control operation.

In some examples, the first semiconductor die includes a plurality of interface blocks (e.g., interface blocks 220) coupled with the logic block that are each operable to access one or more respective memory arrays (e.g., respective memory arrays 250, via one or more interface blocks 245) of the plurality of memory arrays.

In some examples, retrieving the plurality of data segments includes retrieving each of the plurality of data segments from the respective first memory array of the plurality of memory arrays via a respective first interface block of the plurality of interface blocks; and retrieving the error correction information includes retrieving the error correction information from the one or more respective second memory arrays of the plurality of memory arrays via one or more respective second interface blocks of the plurality of interface blocks.

Additionally, or alternatively, in some examples, the command reception component 625 may be configured as or otherwise support a means for receiving, at a logic block of a first semiconductor die of a semiconductor system, a command to read a data segment stored at the semiconductor system, the semiconductor system including a plurality of memory arrays of a set of one or more second semiconductor dies coupled with the first semiconductor die. In some examples, the error control component 640 may be configured as or otherwise support a means for detecting an error in the data segment based on receiving the command to read the data segment. In some examples, the data retrieval component 630 may be configured as or otherwise support a means for retrieving, at the logic block based on detecting the error in the data segment, a plurality of data segments of a data set that includes the data segment, each of the plurality of data segments retrieved from a respective first memory array of the plurality of memory arrays. The parity information retrieval component 645 may be configured as or otherwise support a means for retrieving, at the logic block based on detecting the error in the data segment, parity information associated with the data set, the parity information retrieved from one or more respective second memory arrays of the plurality of memory arrays. In some examples, the error control component 640 may be configured as or otherwise support a means for correcting, at the logic block, the error in the data segment based on the parity information and the plurality of data segments of the data set.

In some examples, the first semiconductor die includes a plurality of interface blocks coupled with the logic block that are each operable to access one or more respective memory arrays of the plurality of memory arrays.

In some examples, the data retrieval component 630 may be configured as or otherwise support a means for retrieving the plurality of data segments includes retrieving each of the plurality of data segments from the respective first memory array of the plurality of memory arrays via a respective first interface block of the plurality of interface blocks. In some examples, the parity information retrieval component 645 may be configured as or otherwise support a means for retrieving the parity information includes retrieving the parity information from the one or more respective second memory arrays of the plurality of memory arrays via one or more respective second interface blocks of the plurality of interface blocks.

In some examples, the error control component 640 may be configured as or otherwise support a means for performing, by an interface block of the plurality of interface blocks, an error control operation on the data segment based on error control information associated with the data segment, and detecting the error in the data segment may be based on performing the error control operation.

In some examples, the command reception component 625 may be configured as or otherwise support a means for receiving, at the logic block, a second command to read a second data segment stored at semiconductor system. In some examples, the data retrieval component 630 may be configured as or otherwise support a means for retrieving, at the logic block, the second data segment based on receiving the second command. In some examples, the data retrieval component 630 may be configured as or otherwise support a means for suppressing, at the logic block, retrieving a second data set including the second data segment and parity information associated with the second data set based on not detecting an error in the second data segment. In some examples, the data output component 655 may be configured as or otherwise support a means for outputting the second data segment from the logic block.

In some examples, the error control component 640 may be configured as or otherwise support a means for performing an Exclusive-OR operation using the parity information and the data set, and correcting the error may be based on performing the Exclusive-OR operation.

In some examples, the data output component 655 may be configured as or otherwise support a means for outputting the data segment from the logic block based on correcting the error.

Additionally, or alternatively, in some examples, the command reception component 625 may be configured as or otherwise support a means for receiving, at a logic block of a first semiconductor die of a semiconductor system, a command to write a data segment at the semiconductor system, the semiconductor system including a plurality of memory arrays of a set of one or more second semiconductor dies coupled with the first semiconductor die. In some examples, the error control component 640 may be configured as or otherwise support a means for modifying, by the logic block, parity information stored at a first memory array of the plurality of memory arrays, the parity information associated with a plurality of data segments of a data set that includes the data segment, each of the plurality of data segments stored at a respective second memory array of the plurality of memory arrays. The data storage component 650 may be configured as or otherwise support a means for modifying, by the logic block, the data set to include the data segment based on writing the data segment to a second memory array of the plurality of memory arrays.

In some examples, to support modifying the parity information, the parity information retrieval component 645 may be configured as or otherwise support a means for retrieving, at the logic block, the parity information from the first memory array. In some examples, to support modifying the parity information, the error control component 640 may be configured as or otherwise support a means for generating, at the logic block, second parity information for the data set based on the parity information and the data segment. In some examples, to support modifying the parity information, the parity information storage component 660 may be configured as or otherwise support a means for writing the second parity information to the first memory array.

In some examples, the data retrieval component 630 may be configured as or otherwise support a means for retrieving, at the logic block, a second data segment of the data set, and generating the second parity information may be based on comparing the data segment with the second data segment.

In some examples, the error control component 640 may be configured as or otherwise support a means for generating, at the logic block, one or more parity bits for the data segment based on receiving the command, and modifying the data set may be based on writing the one or more parity bits to first memory array.

In some examples, the parity information storage component 660 may be configured as or otherwise support a means for transferring the parity information from the first memory array to a third memory array of the plurality of memory arrays.

In some examples, each of the plurality of data segments is stored at a respective second semiconductor die of the set of one or more second semiconductor dies.

In some examples, the first semiconductor die includes a plurality of interface blocks coupled with the logic block that are each operable to access one or more respective memory arrays of the plurality of memory arrays.

In some examples, each of the plurality of interface blocks is coupled with a respective second semiconductor die of the set of one or more second semiconductor dies via a respective channel between each interface block and the respective second semiconductor die.

In some examples, the error control component 640 may be configured as or otherwise support a means for performing an Exclusive-OR operation using the parity information and the data set, and modifying the parity information may be based on performing the Exclusive-OR operation.

In some examples, the described functionality of the logic block 620, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the logic block 620, or various components thereof, may be implemented at least in part by instructions (e.g., stored in memory, non-transitory computer-readable medium) executable by such at least one processor.

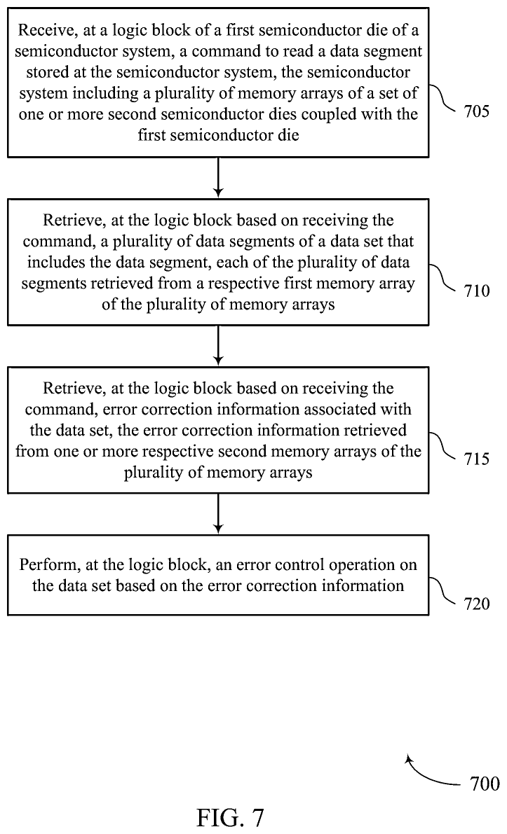

FIG. 7 shows a flowchart illustrating a method 700 that supports data protection techniques in stacked memory architectures in accordance with examples as disclosed herein. The operations of method 700 may be implemented by a logic block or its components as described herein. For example, the operations of method 700 may be performed by a logic block 620, or a logic block 225, an interface block 220, or a combination thereof, as described with reference to FIGS. 1 through 6. In some examples, a logic block may execute a set of instructions to control the functional elements of the device to perform the described functions. Additionally, or alternatively, the logic block may perform aspects of the described functions using special-purpose hardware.

At 705, the method may include receiving, at a logic block of a first semiconductor die of a semiconductor system, a command to read a data segment stored at the semiconductor system, the semiconductor system including a plurality of memory arrays of a set of one or more second semiconductor dies coupled with the first semiconductor die. For example, the first semiconductor die may include a logic block (e.g., a logic block 225) that may receive the command from a controller 215. In some examples, aspects of the operations of 705 may be performed by a command reception component 625 as described with reference to FIG. 6.

At 710, the method may include retrieving, at the logic block based on receiving the command, a plurality of data segments of a data set that includes the data segment, each of the plurality of data segments retrieved from a respective first memory array of the plurality of memory arrays. For example, the logic block may be coupled with one or more interface blocks (e.g., interface blocks 220) that may retrieve respective data segments from respective memory arrays 250. In some examples, aspects of the operations of 710 may be performed by a data retrieval component 630 as described with reference to FIG. 6.

At 715, the method may include retrieving, at the logic block based on receiving the command, error correction information associated with the data set, the error correction information retrieved from one or more respective second memory arrays of the plurality of memory arrays. For example, an interface block 220 may retrieve the error correction information from a memory array 250. In some examples, aspects of the operations of 715 may be performed by an error correction information retrieval component 635 as described with reference to FIG. 6.

At 720, the method may include performing, at the logic block, an error control operation on the data set based on the error correction information. For example, the logic block 225 may include one or more error correction circuits (e.g., of a processor 470) for performing the error control operation. In some examples, aspects of the operations of 720 may be performed by an error control component 640 as described with reference to FIG. 6.

In some examples, an apparatus as described herein may perform a method or methods, such as the method 700. The apparatus may include features, circuitry, logic, means, or instructions (e.g., a non-transitory computer-readable medium storing instructions executable by a processor), or any combination thereof for performing the following aspects of the present disclosure:
Aspect 1: A method, apparatus, or non-transitory computer-readable medium including operations, features, circuitry, logic, means, or instructions, or any combination thereof for receiving, at a logic block of a first semiconductor die of a semiconductor system, a command to read a data segment stored at the semiconductor system, the semiconductor system including a plurality of memory arrays of a set of one or more second semiconductor dies coupled with the first semiconductor die; retrieving, at the logic block based on receiving the command, a plurality of data segments of a data set that includes the data segment, each of the plurality of data segments retrieved from a respective first memory array of the plurality of memory arrays; retrieving, at the logic block based on receiving the command, error correction information associated with the data set, the error correction information retrieved from one or more respective second memory arrays of the plurality of memory arrays; and performing, at the logic block, an error control operation on the data set based on the error correction information.
Aspect 2: The method, apparatus, or non-transitory computer-readable medium of aspect 1, further including operations, features, circuitry, logic, means, or instructions, or any combination thereof for retrieving second error control information associated with the data segment from the respective first memory array of the plurality of memory arrays and performing a second error control operation on the data segment based on second error control information associated with the data segment based on retrieving the data segment.
Aspect 3: The method, apparatus, or non-transitory computer-readable medium of any of aspects 1 through 2, where the error correction information includes a plurality of portions, each portion of the plurality of portions stored at a respective second semiconductor die of the set of one or more second semiconductor dies.
Aspect 4: The method, apparatus, or non-transitory computer-readable medium of any of aspects 1 through 3, where each of the plurality of data segments is stored at a respective second semiconductor die of the set of one or more second semiconductor dies.
Aspect 5: The method, apparatus, or non-transitory computer-readable medium of any of aspects 1 through 4, further including operations, features, circuitry, logic, means, or instructions, or any combination thereof for outputting the data segment from the logic block based on performing the error control operation.
Aspect 6: The method, apparatus, or non-transitory computer-readable medium of any of aspects 1 through 5, where the first semiconductor die includes a plurality of interface blocks coupled with the logic block that are each operable to access one or more respective memory arrays of the plurality of memory arrays.
Aspect 7: The method, apparatus, or non-transitory computer-readable medium of aspect 6, where retrieving the plurality of data segments includes retrieving each of the plurality of data segments from the respective first memory array of the plurality of memory arrays via a respective first interface block of the plurality of interface blocks; and retrieving the error correction information includes retrieving the error correction information from the one or more respective second memory arrays of the plurality of memory arrays via one or more respective second interface blocks of the plurality of interface blocks.

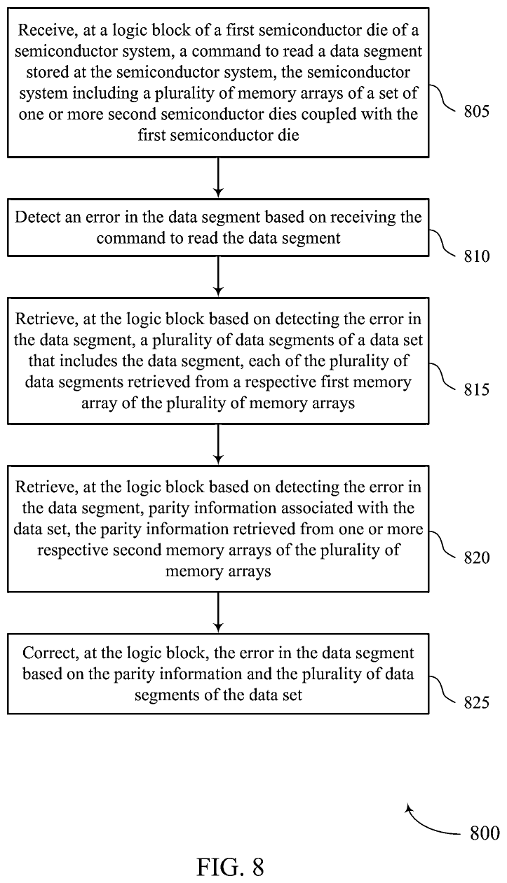

FIG. 8 shows a flowchart illustrating a method 800 that supports data protection techniques in stacked memory architectures in accordance with examples as disclosed herein. The operations of method 800 may be implemented by a logic block or its components as described herein. For example, the operations of method 800 may be performed by a logic block 620, or a logic block 225, an interface block 220, or a combination thereof, as described with reference to FIGS. 1 through 6. In some examples, a logic block may execute a set of instructions to control the functional elements of the device to perform the described functions. Additionally, or alternatively, the logic block may perform aspects of the described functions using special-purpose hardware.

At 805, the method may include receiving, at a logic block of a first semiconductor die of a semiconductor system, a command to read a data segment stored at the semiconductor system, the semiconductor system including a plurality of memory arrays of a set of one or more second semiconductor dies coupled with the first semiconductor die. For example, the first semiconductor die may include a logic block (e.g., a logic block 225) that may receive the command from a controller 215. In some examples, aspects of the operations of 805 may be performed by a command reception component 625 as described with reference to FIG. 6.

At 810, the method may include detecting an error in the data segment based on receiving the command to read the data segment. For example, the logic block 225 may include one or more error correction circuits (e.g., of a processor 470) for detecting the error. In some examples, aspects of the operations of 810 may be performed by an error control component 640 as described with reference to FIG. 6.

At 815, the method may include retrieving, at the logic block based on detecting the error in the data segment, a plurality of data segments of a data set that includes the data segment, each of the plurality of data segments retrieved from a respective first memory array of the plurality of memory arrays. For example, the logic block 225 may be coupled with one or more interface blocks (e.g., interface blocks 220) that may retrieve respective data segments from respective memory arrays 250. In some examples, aspects of the operations of 815 may be performed by a data retrieval component 630 as described with reference to FIG. 6.

At 820, the method may include retrieving, at the logic block based on detecting the error in the data segment, parity information associated with the data set, the parity information retrieved from one or more respective second memory arrays of the plurality of memory arrays. For example, an interface block 220 may retrieve the parity information from a memory array 250. In some examples, aspects of the operations of 820 may be performed by a parity information retrieval component 645 as described with reference to FIG. 6.

At 825, the method may include correcting, at the logic block, the error in the data segment based on the parity information and the plurality of data segments of the data set. For example, the logic block 225 may include one or more error correction circuits (e.g., of a processor 470) for correcting the error. In some examples, aspects of the operations of 825 may be performed by an error control component 640 as described with reference to FIG. 6.

In some examples, an apparatus as described herein may perform a method or methods, such as the method 800. The apparatus may include features, circuitry, logic, means, or instructions (e.g., a non-transitory computer-readable medium storing instructions executable by a processor), or any combination thereof for performing the following aspects of the present disclosure:
Aspect 8: A method, apparatus, or non-transitory computer-readable medium including operations, features, circuitry, logic, means, or instructions, or any combination thereof for receiving, at a logic block of a first semiconductor die of a semiconductor system, a command to read a data segment stored at the semiconductor system, the semiconductor system including a plurality of memory arrays of a set of one or more second semiconductor dies coupled with the first semiconductor die; detecting an error in the data segment based on receiving the command to read the data segment; retrieving, at the logic block based on detecting the error in the data segment, a plurality of data segments of a data set that includes the data segment, each of the plurality of data segments retrieved from a respective first memory array of the plurality of memory arrays; retrieving, at the logic block based on detecting the error in the data segment, parity information associated with the data set, the parity information retrieved from one or more respective second memory arrays of the plurality of memory arrays; and correcting, at the logic block, the error in the data segment based on the parity information and the plurality of data segments of the data set.
Aspect 9: The method, apparatus, or non-transitory computer-readable medium of aspect 8, where the first semiconductor die includes a plurality of interface blocks coupled with the logic block that are each operable to access one or more respective memory arrays of the plurality of memory arrays.
Aspect 10: The method, apparatus, or non-transitory computer-readable medium of aspect 9, further including operations, features, circuitry, logic, means, or instructions, or any combination thereof for retrieving the plurality of data segments includes retrieving each of the plurality of data segments from the respective first memory array of the plurality of memory arrays via a respective first interface block of the plurality of interface blocks and retrieving the parity information includes retrieving the parity information from the one or more respective second memory arrays of the plurality of memory arrays via one or more respective second interface blocks of the plurality of interface blocks.
Aspect 11: The method, apparatus, or non-transitory computer-readable medium of any of aspects 9 through 10, further including operations, features, circuitry, logic, means, or instructions, or any combination thereof for performing, by an interface block of the plurality of interface blocks, an error control operation on the data segment based on error control information associated with the data segment, where detecting the error in the data segment is based on performing the error control operation.
Aspect 12: The method, apparatus, or non-transitory computer-readable medium of any of aspects 8 through 11, further including operations, features, circuitry, logic, means, or instructions, or any combination thereof for receiving, at the logic block, a second command to read a second data segment stored at semiconductor system; retrieving, at the logic block, the second data segment based on receiving the second command; suppressing, at the logic block, retrieving a second data set including the second data segment and parity information associated with the second data set based on not detecting an error in the second data segment; and outputting the second data segment from the logic block.
Aspect 13: The method, apparatus, or non-transitory computer-readable medium of any of aspects 8 through 12, further including operations, features, circuitry, logic, means, or instructions, or any combination thereof for performing an Exclusive-OR operation using the parity information and the data set, where correcting the error is based on performing the Exclusive-OR operation.
Aspect 14: The method, apparatus, or non-transitory computer-readable medium of any of aspects 8 through 13, further including operations, features, circuitry, logic, means, or instructions, or any combination thereof for outputting the data segment from the logic block based on correcting the error.

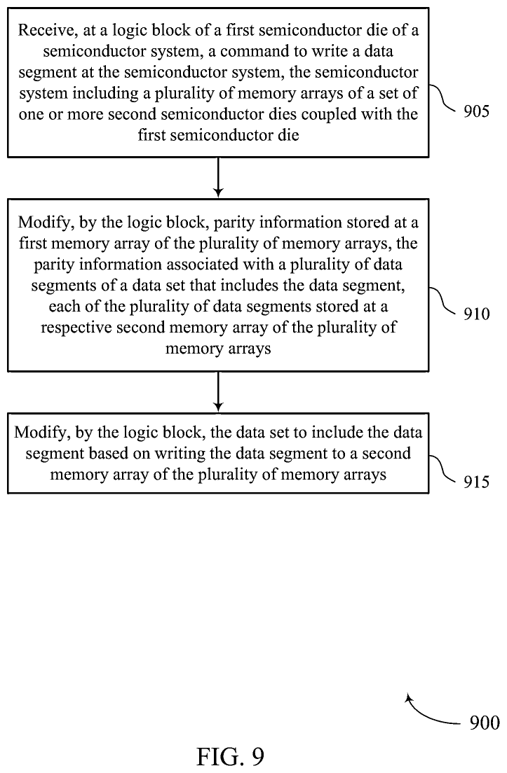

FIG. 9 shows a flowchart illustrating a method 900 that supports data protection techniques in stacked memory architectures in accordance with examples as disclosed herein. The operations of method 900 may be implemented by a logic block or its components as described herein. For example, the operations of method 900 may be performed by a logic block 620, or a logic block 225, an interface block 220, or a combination thereof, as described with reference to FIGS. 1 through 6. In some examples, a logic block may execute a set of instructions to control the functional elements of the device to perform the described functions. Additionally, or alternatively, the logic block may perform aspects of the described functions using special-purpose hardware.

At 905, the method may include receiving, at a logic block of a first semiconductor die of a semiconductor system, a command to write a data segment at the semiconductor system, the semiconductor system including a plurality of memory arrays of a set of one or more second semiconductor dies coupled with the first semiconductor die. For example, the first semiconductor die may include a logic block (e.g., a logic block 225) that may receive the command from a controller 215. In some examples, aspects of the operations of 905 may be performed by a command reception component 625 as described with reference to FIG. 6.

At 910, the method may include modifying, by the logic block, parity information stored at a first memory array of the plurality of memory arrays, the parity information associated with a plurality of data segments of a data set that includes the data segment, each of the plurality of data segments stored at a respective second memory array of the plurality of memory arrays. For example, the logic block 225 may include circuitry (e.g., of a processor 470) operable to modify the parity information. In some examples, aspects of the operations of 910 may be performed by an error control component 640 as described with reference to FIG. 6.

At 915, the method may include modifying, by the logic block, the data set to include the data segment based on writing the data segment to a second memory array of the plurality of memory arrays. For example, the logic block 225 may include circuitry (e.g., of a processor 470) operable to modify the data segment. In some examples, aspects of the operations of 915 may be performed by a data storage component 650 as described with reference to FIG. 6.

In some examples, an apparatus as described herein may perform a method or methods, such as the method 900. The apparatus may include features, circuitry, logic, means, or instructions (e.g., a non-transitory computer-readable medium storing instructions executable by a processor), or any combination thereof for performing the following aspects of the present disclosure:
Aspect 15: A method, apparatus, or non-transitory computer-readable medium including operations, features, circuitry, logic, means, or instructions, or any combination thereof for receiving, at a logic block of a first semiconductor die of a semiconductor system, a command to write a data segment at the semiconductor system, the semiconductor system including a plurality of memory arrays of a set of one or more second semiconductor dies coupled with the first semiconductor die; modifying, by the logic block, parity information stored at a first memory array of the plurality of memory arrays, the parity information associated with a plurality of data segments of a data set that includes the data segment, each of the plurality of data segments stored at a respective second memory array of the plurality of memory arrays; and modifying, by the logic block, the data set to include the data segment based on writing the data segment to a second memory array of the plurality of memory arrays.
Aspect 16: The method, apparatus, or non-transitory computer-readable medium of aspect 15, where modifying the parity information includes operations, features, circuitry, logic, means, or instructions, or any combination thereof for retrieving, at the logic block, the parity information from the first memory array; generating, at the logic block, second parity information for the data set based on the parity information and the data segment; and writing the second parity information to the first memory array.
Aspect 17: The method, apparatus, or non-transitory computer-readable medium of aspect 16, further including operations, features, circuitry, logic, means, or instructions, or any combination thereof for retrieving, at the logic block, a second data segment of the data set, where generating the second parity information is based on comparing the data segment with the second data segment.
Aspect 18: The method, apparatus, or non-transitory computer-readable medium of any of aspects 15 through 17, further including operations, features, circuitry, logic, means, or instructions, or any combination thereof for generating, at the logic block, one or more parity bits for the data segment based on receiving the command, where modifying the data set is based on writing the one or more parity bits to first memory array.
Aspect 19: The method, apparatus, or non-transitory computer-readable medium of any of aspects 15 through 18, further including operations, features, circuitry, logic, means, or instructions, or any combination thereof for transferring the parity information from the first memory array to a third memory array of the plurality of memory arrays.
Aspect 20: The method, apparatus, or non-transitory computer-readable medium of any of aspects 15 through 19, where each of the plurality of data segments is stored at a respective second semiconductor die of the set of one or more second semiconductor dies.
Aspect 21: The method, apparatus, or non-transitory computer-readable medium of any of aspects 15 through 20, where the first semiconductor die includes a plurality of interface blocks coupled with the logic block that are each operable to access one or more respective memory arrays of the plurality of memory arrays.
Aspect 22: The method, apparatus, or non-transitory computer-readable medium of aspect 21, where each of the plurality of interface blocks is coupled with a respective second semiconductor die of the set of one or more second semiconductor dies via a respective channel between each interface block and the respective second semiconductor die.
Aspect 23: The method, apparatus, or non-transitory computer-readable medium of any of aspects 15 through 22, further including operations, features, circuitry, logic, means, or instructions, or any combination thereof for performing an Exclusive-OR operation using the parity information and the data set, where modifying the parity information is based on performing the Exclusive-OR operation.

It should be noted that the aspects described herein describe possible implementations, and that the operations and the steps may be rearranged or otherwise modified and that other implementations are possible. Further, portions from two or more of the methods may be combined.

A system is described. The following provides an overview of aspects of the system as described herein:
Aspect 24: A system, including: a set of one or more second semiconductor dies of a semiconductor system, the set of one or more second semiconductor dies including a plurality of memory arrays; and a first semiconductor die of the semiconductor system coupled with the set of one or more second semiconductor dies, the first semiconductor die including a logic block configured to: receive a command to read a data segment stored at the semiconductor system; retrieve, based on receiving the command, a plurality of data segments of a data set that includes the data segment, each of the plurality of data segments retrieved from a respective first memory array of the plurality of memory arrays; retrieve, based on receiving the command, error correction information associated with the data set, the error correction information retrieved from one or more respective second memory arrays of the plurality of memory arrays; and perform an error control operation on the data set based on the error correction information.
Aspect 25: The system of aspect 24, where the first semiconductor die further includes a plurality of interface blocks coupled with the logic block that are each operable to access one or more respective memory arrays of the plurality of memory arrays.
Aspect 26: The system of aspect 25, where: to retrieve the plurality of data segments, the logic block is further configured to retrieve the plurality of data segments via a respective first interface block of the plurality of interface blocks; and to retrieve the error correction information, the logic block is further configured to retrieve the error correction information via one or more respective second interface blocks of the plurality of interface blocks.

An system is described. The following provides an overview of aspects of the system as described herein:
Aspect 27: A system, including: a set of one or more second semiconductor dies of a semiconductor system, the set of one or more second semiconductor dies including a plurality of memory arrays; and a first semiconductor die of the semiconductor system coupled with the set of one or more second semiconductor dies, the first semiconductor die including a logic block configured to: receive a command to read a data segment from the semiconductor system; detect an error in the data segment based on receiving the command to read the data segment; retrieve, based on detecting the error in the data segment, a plurality of data segments of a data set that includes the data segment, each of the plurality of data segments retrieved from a respective first memory array of the plurality of memory arrays; retrieve, based on detecting the error in the data segment, parity information associated with the data set, the parity information retrieved from one or more respective second memory arrays of the plurality of memory arrays; and correct the error in the data segment based on the parity information and the plurality of data segments of the data set.
Aspect 28: The system of aspect 27, where the first semiconductor die further includes a plurality of interface blocks coupled with the logic block that are each operable to access one or more respective memory arrays of the plurality of memory arrays.
Aspect 29: The system of aspect 28, where: to retrieve the plurality of data segments, the logic block is further configured to retrieve the plurality of data segments via a respective first interface block of the plurality of interface blocks; and to retrieve the parity information, the logic block is further configured to retrieve the parity information via one or more respective second interface blocks of the plurality of interface blocks.
Aspect 30: The system of any of aspects 28 through 29, where an interface block of the plurality of interface blocks is configured to: perform an error control operation on the data segment based on error control information associated with the data segment, where detecting the error in the data segment is based on performing the error control operation.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (e.g., in conductive contact with, connected with, coupled with) one another if there is any electrical path (e.g., conductive path) between the components that can, at any time, support the flow of signals (e.g., charge, current, voltage) between the components. A conductive path between components that are in electronic communication with each other (e.g., in conductive contact with, connected with, coupled with) may be an open circuit or a closed circuit based on the operation of the device that includes the connected components. A conductive path between connected components may be a direct conductive path between the components or may be an indirect conductive path that includes intermediate components, such as switches, transistors, or other components. In some examples, the flow of signals between the connected components may be interrupted for a time, for example, using one or more intermediate components such as switches or transistors.

A switching component (e.g., a transistor) discussed herein may be a field-effect transistor (FET), and may include a source (e.g., a source terminal), a drain (e.g., a drain terminal), a channel between the source and drain, and a gate (e.g., a gate terminal). A conductivity of the channel may be controlled (e.g., modulated) by applying a voltage to the gate which, in some examples, may result in the channel becoming conductive. A switching component may be an example of an n-type FET or a p-type FET.

The description set forth herein, in connection with the appended drawings, describes example configurations and does not represent all the examples that may be implemented or that are within the scope of the claims. The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Similar components may be distinguished by following the reference label by one or more dashes and additional labeling that distinguishes among the similar components. If just the first reference label is used in the specification, the description is applicable to any one of the similar components having the same first reference label irrespective of the additional reference labels.

The functions described herein may be implemented in hardware, software executed by a processing system (e.g., one or more processors, one or more controllers, control circuitry processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processor. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, that can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or a processor.

The descriptions and drawings are provided to enable a person having ordinary skill in the art to make or use the disclosure. Various modifications to the disclosure will be apparent to the person having ordinary skill in the art, and the techniques disclosed herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method, comprising:
receiving, at a logic block of a first semiconductor die of a semiconductor system, a command to read a data segment stored at the semiconductor system, the semiconductor system comprising a plurality of memory arrays of a set of one or more second semiconductor dies coupled with the first semiconductor die;
detecting an error in the data segment based on receiving the command to read the data segment;
retrieving, at the logic block based on detecting the error in the data segment, a plurality of data segments of a data set that includes the data segment, each of the plurality of data segments retrieved from a respective first memory array of the plurality of memory arrays;
retrieving, at the logic block based on detecting the error in the data segment, parity information associated with the data set, the parity information retrieved from one or more respective second memory arrays of the plurality of memory arrays; and
correcting, at the logic block, the error in the data segment based on the parity information and the plurality of data segments of the data set.

2. The method of claim 1, wherein the first semiconductor die comprises a plurality of interface blocks coupled with the logic block that are each operable to access or more respective memory arrays of the plurality of memory arrays.

3. The method of claim 2, wherein:
retrieving the plurality of data segments comprises retrieving each of the plurality of data segments from the respective first memory array of the plurality of memory arrays via a respective first interface block of the plurality of interface blocks; and
retrieving the parity information comprises retrieving the parity information from the one or more respective second memory arrays of the plurality of memory arrays via one or more respective second interface blocks of the plurality of interface blocks.

4. The method of claim 2, further comprising:
performing, by an interface block of the plurality of interface blocks, an error control operation on the data segment based on error control information associated with the data segment, wherein detecting the error in the data segment is based on performing the error control operation.

5. The method of claim 1, further comprising:
receiving, at the logic block, a second command to read a second data segment stored at semiconductor system;
retrieving, at the logic block, the second data segment based on receiving the second command;
suppressing, at the logic block, retrieving a second data set comprising the second data segment and parity information associated with the second data set based on not detecting an error in the second data segment; and
outputting the second data segment from the logic block.

6. The method of claim 1, further comprising:
performing an Exclusive-OR operation using the parity information and the data set, wherein correcting the error is based on performing the Exclusive-OR operation.

7. The method of claim 1, further comprising:
outputting the data segment from the logic block based on correcting the error.

8. A method, comprising:
receiving, at a logic block of a first semiconductor die of a semiconductor system, a command to write a data segment at the semiconductor system, the semiconductor system comprising a plurality of memory arrays of a set of one or more second semiconductor dies coupled with the first semiconductor die;
modifying, by the logic block, parity information stored at a first memory array of the plurality of memory arrays, the parity information associated with a plurality of data segments of a data set that includes the data segment, each of the plurality of data segments stored at a respective second memory array of the plurality of memory arrays; and
modifying, by the logic block, the data set to include the data segment based on writing the data segment to a second memory array of the plurality of memory arrays.

9. The method of claim 8, wherein modifying the parity information comprises:
retrieving, at the logic block, the parity information from the first memory array;
generating, at the logic block, second parity information for the data set based on the parity information and the data segment; and
writing the second parity information to the first memory array.

10. The method of claim 9, further comprising:
retrieving, at the logic block, a second data segment of the data set, wherein generating the second parity information is based on comparing the data segment with the second data segment.

11. The method of claim 8, further comprising:
generating, at the logic block, one or more parity bits for the data segment based on receiving the command, wherein modifying the data set is based on writing the one or more parity bits to first memory array.

12. The method of claim 8, further comprising:
transferring the parity information from the first memory array to a third memory array of the plurality of memory arrays.

13. The method of claim 8, wherein each of the plurality of data segments is stored at a respective second semiconductor die of the set of one or more second semiconductor dies.

14. The method of claim 8, wherein the first semiconductor die comprises a plurality of interface blocks coupled with the logic block that are each operable to access or more respective memory arrays of the plurality of memory arrays.

15. The method of claim 14, wherein each of the plurality of interface blocks is coupled with a respective second semiconductor die of the set of one or more second semiconductor dies via a respective channel between each interface block and the respective second semiconductor die.

16. The method of claim 8, further comprising:
performing an Exclusive-OR operation using the parity information and the data set, wherein modifying the parity information is based on performing the Exclusive-OR operation.

17. A method, comprising:
receiving, at a logic block of a first semiconductor die of a semiconductor system, a command to read a data segment stored at the semiconductor system, the semiconductor system comprising a plurality of memory arrays of a set of one or more second semiconductor dies coupled with the first semiconductor die;
retrieving, at the logic block based on receiving the command, a plurality of data segments of a data set that includes the data segment, each of the plurality of data segments retrieved from a respective first memory array of the plurality of memory arrays;
retrieving, at the logic block based on receiving the command, error correction information associated with the data set, the error correction information retrieved from one or more respective second memory arrays of the plurality of memory arrays; and
performing, at the logic block, an error control operation on the data set based on the error correction information.

18. The method of claim 17, further comprising:
retrieving second error control information associated with the data segment from the respective first memory array of the plurality of memory arrays; and
performing a second error control operation on the data segment based on second error control information associated with the data segment based on retrieving the data segment.

19. The method of claim 17, wherein the error correction information comprises a plurality of portions, each portion of the plurality of portions stored at a respective second semiconductor die of the set of one or more second semiconductor dies.

20. The method of claim 17, wherein each of the plurality of data segments is stored at a respective second semiconductor die of the set of one or more second semiconductor dies.

21. The method of claim 17, further comprising:
outputting the data segment from the logic block based on performing the error control operation.

22. The method of claim 17, wherein the first semiconductor die comprises a plurality of interface blocks coupled with the logic block that are each operable to access or more respective memory arrays of the plurality of memory arrays.

23. The method of claim 22, wherein:
retrieving the plurality of data segments comprises retrieving each of the plurality of data segments from the respective first memory array of the plurality of memory arrays via a respective first interface block of the plurality of interface blocks; and
retrieving the error correction information comprises retrieving the error correction information from the one or more respective second memory arrays of the plurality of memory arrays via one or more respective second interface blocks of the plurality of interface blocks.

24. A system, comprising:
a set of one or more second semiconductor dies of a semiconductor system, the set of one or more second semiconductor dies comprising a plurality of memory arrays; and
a first semiconductor die of the semiconductor system coupled with the set of one or more second semiconductor dies, the first semiconductor die comprising a logic block configured to:
receive a command to read a data segment from the semiconductor system;
detect an error in the data segment based on receiving the command to read the data segment;
retrieve, based on detecting the error in the data segment, a plurality of data segments of a data set that includes the data segment, each of the plurality of data segments retrieved from a respective first memory array of the plurality of memory arrays;
retrieve, based on detecting the error in the data segment, parity information associated with the data set, the parity information retrieved from one or more respective second memory arrays of the plurality of memory arrays; and
correct the error in the data segment based on the parity information and the plurality of data segments of the data set.

25. The system of claim 24, wherein the first semiconductor die further comprises a plurality of interface blocks coupled with the logic block that are each operable to access one or more respective memory arrays of the plurality of memory arrays.

26. The system of claim 25, wherein:
to retrieve the plurality of data segments, the logic block is further configured to retrieve the plurality of data segments via a respective first interface block of the plurality of interface blocks; and
to retrieve the parity information, the logic block is further configured to retrieve the parity information via one or more respective second interface blocks of the plurality of interface blocks.

27. The system of claim 25, wherein an interface block of the plurality of interface blocks is configured to:
perform an error control operation on the data segment based on error control information associated with the data segment, wherein detecting the error in the data segment is based on performing the error control operation.

28. A system, comprising:
a set of one or more second semiconductor dies of a semiconductor system, the set of one or more second semiconductor dies comprising a plurality of memory arrays; and
a first semiconductor die of the semiconductor system coupled with the set of one or more second semiconductor dies, the first semiconductor die comprising a logic block configured to:
receive a command to read a data segment stored at the semiconductor system;
retrieve, based on receiving the command, a plurality of data segments of a data set that includes the data segment, each of the plurality of data segments retrieved from a respective first memory array of the plurality of memory arrays;
retrieve, based on receiving the command, error correction information associated with the data set, the error correction information retrieved from one or more respective second memory arrays of the plurality of memory arrays; and
perform an error control operation on the data set based on the error correction information.

29. The system of claim 28, wherein the first semiconductor die further comprises a plurality of interface blocks coupled with the logic block that are each operable to access one or more respective memory arrays of the plurality of memory arrays.

30. The system of claim 29, wherein:
to retrieve the plurality of data segments, the logic block is further configured to retrieve the plurality of data segments via a respective first interface block of the plurality of interface blocks; and
to retrieve the error correction information, the logic block is further configured to retrieve the error correction information via one or more respective second interface blocks of the plurality of interface blocks.
